(19) United States
(12) Patent Application Publication
(10) Pub. No.: US 2024/0214531 A1
(43) Pub. Date: Jun. 27, 2024

(54) CONTROL DEVICE, CONTROL METHOD, CONTROL PROGRAM, AND PROJECTION SYSTEM

(71) Applicant: FUJIFILM Corporation, Tokyo (JP)

(72) Inventors: Kazuyuki ITAGAKI, Saitama-shi (JP); Kenshi IMAMURA, Saitama-shi (JP)

(73) Assignee: FUJIFILM Corporation, Tokyo (JP)

(21) Appl. No.: 18/595,512

(22) Filed: Mar. 5, 2024

Related U.S. Application Data
(63) Continuation of application No. PCT/JP2022/030619, filed on Aug. 10, 2022.

(30) Foreign Application Priority Data
Sep. 27, 2021 (JP) 2021-157091

(51) Int. Cl. H04N 9/31

(52) U.S. Cl. CPC H04N 9/3182; H04N 9/3191

(57) ABSTRACT

A control device includes a processor, and the processor is configured to perform a control of: projecting a first image from a plurality of projection apparatuses at different timings; projecting a second image including markers having different colors from at least two or more projection apparatuses of the plurality of projection apparatuses based on captured data of the projected first image; and adjusting a relative projection position among the plurality of projection apparatuses based on captured data of the projected second image.

### CROSS REFERENCE TO RELATED APPLICATION

This is a continuation of International Application No. PCT/JP2022/030619 filed on Aug. 10, 2022, and claims priority from Japanese Patent Application No. 2021-157091 filed on Sep. 27, 2021, the entire disclosures of which are incorporated herein by reference.

### BACKGROUND OF THE INVENTION

### 1. Field of the Invention

The present invention relates to a control device, a control method, a computer readable medium storing a control program, and a projection system.

### 2. Description of the Related Art

JP2021-085907A discloses an image processing apparatus that projects a first image and a second image including marker images different from each other and pattern images different from each other to a projection surface in a superimposed manner, identifies the first images from a captured image generated by capturing the first image and the second image based on the marker images, corrects distortion of a first pattern image included in the first image, and determines a position at which the first image is projected to the projection surface by performing pattern matching between the first pattern image after correction and a reference pattern image.

JP2014-086788A discloses a projection control device that projects an adjustment chart indicating a projectable region for each of a plurality of projection apparatuses which project images toward an object for projection, in which even in a case where only a part of the adjustment chart is projected to the object for projection, a contour of the projectable region is specified based on the part.

JP2012-142669A discloses a projection control device that, in displaying a combined image of a plurality of projection images projected from a plurality of projectors on a screen, captures a plurality of test charts projected onto the screen from the plurality of projectors and that determines a plurality of projection regions of the plurality of projectors based on a capturing result.

### SUMMARY OF THE INVENTION

One embodiment according to the disclosed technology provides a control device, a control method, a control program stored in a computer readable medium, and a projection system that can accurately adjust a relative projection position among a plurality of projection apparatuses.

A control device according to an aspect of the present invention is a control device comprising a processor, in which the processor is configured to perform a control of projecting a first image from a plurality of projection apparatuses at different timings, projecting a second image including markers having different colors from at least two or more projection apparatuses of the plurality of projection apparatuses based on captured data of the projected first image, and adjusting a relative projection position among the plurality of projection apparatuses based on captured data of the projected second image.

A control method according to another aspect of the present invention is performing, via a processor included in a control device, a control of projecting a first image from a plurality of projection apparatuses at different timings, projecting a second image including markers having different colors from at least two or more projection apparatuses of the plurality of projection apparatuses based on captured data of the projected first image, and adjusting a relative projection position among the plurality of projection apparatuses based on captured data of the projected second image.

A control program stored in a computer readable medium according to still another aspect of the present invention causes a processor included in a control device to execute a control of projecting a first image from a plurality of projection apparatuses at different timings, projecting a second image including markers having different colors from at least two or more projection apparatuses of the plurality of projection apparatuses based on captured data of the projected first image, and adjusting a relative projection position among the plurality of projection apparatuses based on captured data of the projected second image.

A projection system according to still another aspect of the present invention is a projection system comprising a plurality of projection apparatuses, and a control device including a processor, in which the processor is configured to perform a control of projecting a first image from a plurality of projection apparatuses at different timings, projecting a second image including markers having different colors from at least two or more projection apparatuses of the plurality of projection apparatuses based on captured data of the projected first image, and adjusting a relative projection position among the plurality of projection apparatuses based on captured data of the projected second image.

According to the present invention, a control device, a control method, and a control program stored in a computer readable medium, and a projection system that can accurately adjust a relative projection position among a plurality of projection apparatuses can be provided.

### BRIEF DESCRIPTION OF THE DRAWINGS

FIG. 1 is a diagram illustrating an example of a projection system 100 of an embodiment.

FIG. 2 is a diagram illustrating an example of a first projection apparatus 10a and a second projection apparatus 10b.

FIG. 3 is a schematic diagram illustrating an example of an internal configuration of a projection portion 1.

FIG. 4 is a schematic diagram illustrating an exterior configuration of a projection apparatus 10.

FIG. 5 is a schematic cross-sectional view of an optical unit 106 of the projection apparatus 10 illustrated in FIG. 4.

FIG. 6 is a diagram illustrating an example of a hardware configuration of a computer 50.

FIG. 7 is a flowchart illustrating an example of a control by the computer 50.

FIG. 8 is a diagram illustrating an example of projection of test images by the first projection apparatus 10a.

FIG. 9 is a diagram illustrating an example of projection of test images by the second projection apparatus 10b.

FIG. 10 is a diagram illustrating an example of projection of marker images by the first projection apparatus 10a and the second projection apparatus 10b.

FIG. 11 is a diagram illustrating an example of adjustment of a projection position for stack projection.

FIG. 12 is a diagram illustrating an example of a state before adjustment of the projection position for blending projection.

FIG. 13 is a diagram illustrating an example of adjustment of the projection position for the blending projection.

FIG. 14 is a flowchart illustrating an example of optimization processing of a marker re-search range by the computer 50.

FIG. 15 is a diagram for describing an example of optimization of the marker re-search range.

FIG. 16 is a flowchart illustrating an example of optimization processing of a marker disposition by the computer 50.

FIG. 17 is a diagram (Part 1) for describing an example of optimization of the marker disposition.

FIG. 18 is a diagram (Part 2) for describing an example of optimization of the marker disposition.

FIG. 19 is a schematic diagram illustrating another exterior configuration of the projection apparatus 10.

FIG. 20 is a schematic cross-sectional view of the optical unit 106 of the projection apparatus 10 illustrated in FIG. 19.

### DESCRIPTION OF THE PREFERRED EMBODIMENTS

Hereinafter, an example of an embodiment of the present invention will be described with reference to the drawings.

### Embodiment

### <Projection System 100 of Embodiment>

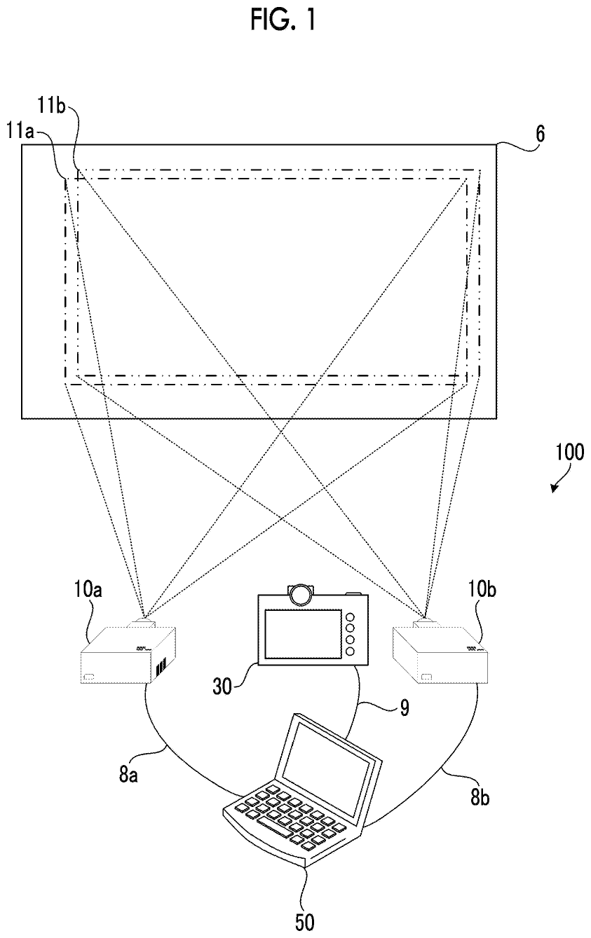

FIG. 1 is a diagram illustrating an example of a projection system 100 of the embodiment. As illustrated in FIG. 1, the projection system 100 comprises a first projection apparatus 10a, a second projection apparatus 10b, a computer 50, and an imaging apparatus 30. The computer 50 is an example of a control device according to the embodiment of the present invention.

The computer 50 can communicate with the first projection apparatus 10a, the second projection apparatus 10b, and the imaging apparatus 30. In the example illustrated in FIG. 1, the computer 50 is connected to the first projection apparatus 10a through a communication cable 8a to be capable of communicating with the first projection apparatus 10a. In addition, the computer 50 is connected to the second projection apparatus 10b through a communication cable 8b to be capable of communicating with the second projection apparatus 10b. In addition, the computer 50 is connected to the imaging apparatus 30 through a communication cable 9 to be capable of communicating with the imaging apparatus 30.

The first projection apparatus 10a and the second projection apparatus 10b are projection apparatuses that can perform projection to a projection target object 6. The imaging apparatus 30 is an imaging apparatus that can capture images projected to the projection target object 6 by the first projection apparatus 10a and the second projection apparatus 10b.

The projection target object 6 is an object such as a screen having a projection surface on which a projection image is displayed by the first projection apparatus 10a. In the example illustrated in FIG. 1, the projection surface of the projection target object 6 is a rectangular plane. It is assumed that upper, lower, left, and right sides of the projection target object 6 in FIG. 1 are upper, lower, left, and right sides of the actual projection target object 6.

A projection range 11a illustrated by a dot dashed line is a region that is irradiated with projection light by the first projection apparatus 10a in the projection target object 6. The projection range 11a is a part or the entirety of a projectable range within which the projection can be performed by the first projection apparatus 10a. A projection range 11b illustrated by a double dot dashed line is a region that is irradiated with projection light by the second projection apparatus 10b in the projection target object 6. The projection range 11b is a part or the entirety of a projectable range within which the projection can be performed by the second projection apparatus 10b. In the example illustrated in FIG. 1, the projection ranges 11a and 11b are rectangular.

<First Projection Apparatus 10a and Second Projection Apparatus 10b>

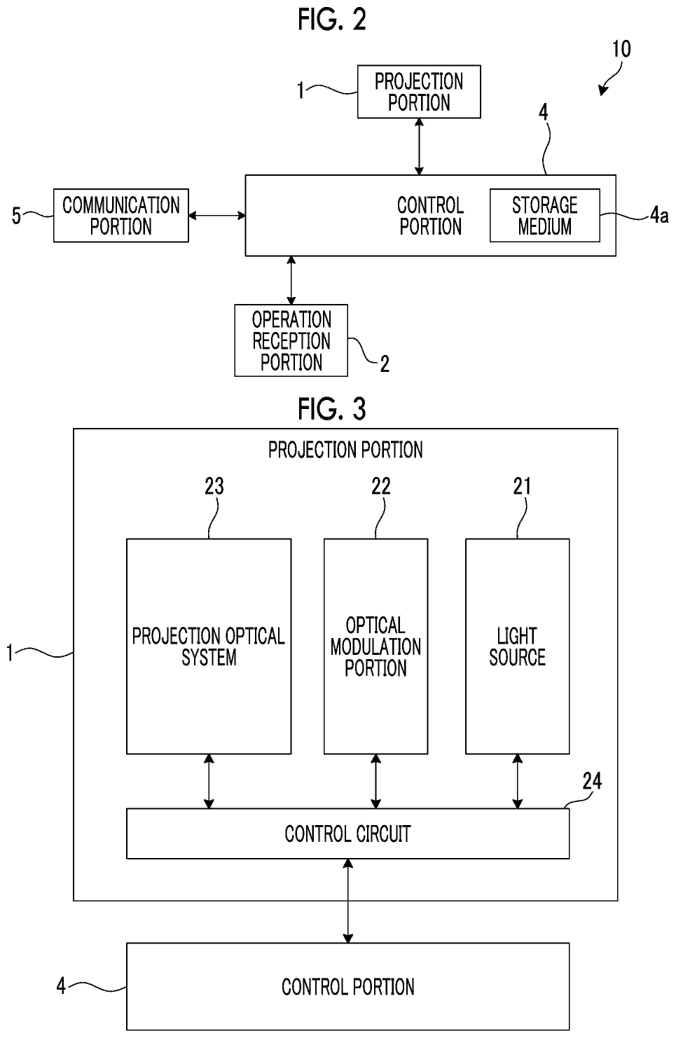

FIG. 2 is a diagram illustrating an example of the first projection apparatus 10a and the second projection apparatus 10b. Each of the first projection apparatus 10a and the second projection apparatus 10b is composed of, for example, a projection apparatus 10 illustrated in FIG. 2. The projection apparatus 10 comprises a projection portion 1, a control portion 4, an operation reception portion 2, and a communication portion 5. The projection portion 1 is composed of, for example, a liquid crystal projector or a projector using liquid crystal on silicon (LCOS). Hereinafter, the projection portion 1 will be described as a liquid crystal projector.

The control portion 4 controls the projection performed by the projection apparatus 10. The control portion 4 is a device including a control portion composed of various processors, a communication interface (not illustrated) for communicating with each portion, and a storage medium 4a such as a hard disk, a solid state drive (SSD), or a read only memory (ROM) and generally controls the projection portion 1. Examples of the various processors of the control portion of the control portion 4 include a central processing unit (CPU) that is a general-purpose processor performing various types of processing by executing a program, a programmable logic device (PLD) such as a field programmable gate array (FPGA) that is a processor having a circuit configuration changeable after manufacture, or a dedicated electric circuit such as an application specific integrated circuit (ASIC) that is a processor having a circuit configuration dedicatedly designed to execute specific processing.

More specifically, a structure of these various processors is an electric circuit in which circuit elements such as semiconductor elements are combined. The control portion of the control portion 4 may be composed of one of the various processors or may be composed of a combination of two or more processors of the same type or different types (for example, a combination of a plurality of FPGAs or a combination of a CPU and an FPGA).

The operation reception portion 2 detects an instruction (user instruction) from a user by receiving various operations from the user. The operation reception portion 2 may be a button, a key, a joystick, or the like provided in the control portion 4 or a reception portion or the like that receives a signal from a remote controller for remotely operating the control portion 4.

The communication portion 5 is a communication interface that can communicate with the computer 50. The communication portion 5 may be a wired communication interface that performs wired communication as illustrated in FIG. 1, or a wireless communication interface that performs wireless communication.

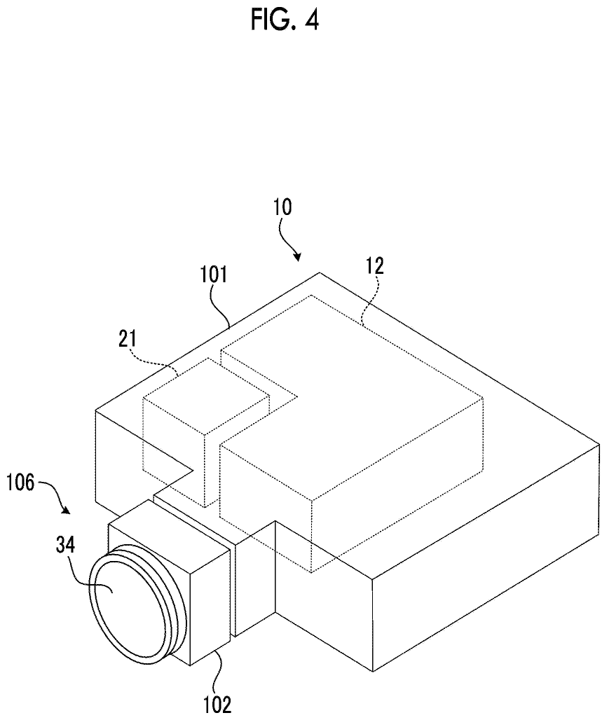

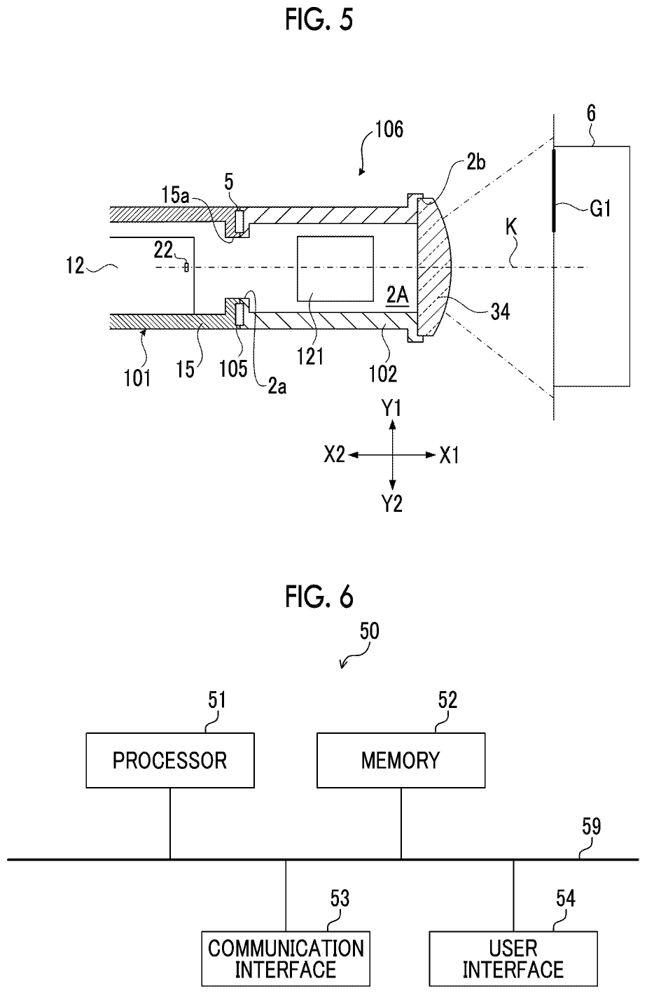

The projection portion 1, the control portion 4, and the operation reception portion 2 are implemented by, for example, one device (for example, refer to FIG. 4 and FIG. 5). Alternatively, the projection portion 1, the control portion 4, and the operation reception portion 2 may be separate devices that cooperate by communicating with each other.

### <Internal Configuration of Projection Portion 1>

FIG. 3 is a schematic diagram illustrating an example of an internal configuration of the projection portion 1. As illustrated in FIG. 3, the projection portion 1 of the projection apparatus 10 illustrated in FIG. 2 comprises a light source 21, an optical modulation portion 22, a projection optical system 23, and a control circuit 24. The light source 21 includes a light emitting element such as a laser or a light emitting diode (LED) and emits, for example, white light.

The optical modulation portion 22 is composed of three liquid crystal panels (optical modulation elements) that emit each color image by modulating, based on image information, each color light which is emitted from the light source 21 and separated into three colors of red, blue, and green by a color separation mechanism, not illustrated, and a dichroic prism that mixes each color image emitted from the three liquid crystal panels and that emits the mixed color image in the same direction. Each color image may be emitted by mounting filters of red, blue, and green in each of the three liquid crystal panels and modulating the white light emitted from the light source 21 via each liquid crystal panel.

The light from the light source 21 and the optical modulation portion 22 is incident on the projection optical system 23. The projection optical system 23 includes at least one lens and is composed of, for example, a relay optical system. The light that has passed through the projection optical system 23 is projected to the projection target object 6.

In the projection target object 6, a region irradiated with the light transmitted through the entire range of the optical modulation portion 22 is the projectable range within which the projection can be performed by the projection portion 1. In the projectable range, a region that is irradiated with the light actually transmitted through the optical modulation portion 22 is the projection range (the projection range 11a or the projection range 11b) of the projection portion 1. For example, in the projectable range, a size, a position, and a shape of the projection range of the projection portion 1 are changed by controlling a size, a position, and a shape of a region through which the light is transmitted in the optical modulation portion 22.

The control circuit 24 projects an image based on display data to the projection target object 6 by controlling the light source 21, the optical modulation portion 22, and the projection optical system 23 based on the display data input from the control portion 4. The display data input into the control circuit 24 is composed of three pieces of data including red display data, blue display data, and green display data.

In addition, the control circuit 24 enlarges or reduces the projection range of the projection portion 1 by changing the projection optical system 23 based on an instruction input from the control portion 4. In addition, the control portion 4 may move the projection range of the projection portion 1 by changing the projection optical system 23 based on an operation received from the user by the operation reception portion 2.

In addition, the projection apparatus 10 comprises a shift mechanism that mechanically or optically moves the projection range of the projection portion 1 while maintaining an image circle of the projection optical system 23. The image circle of the projection optical system 23 is a region in which the projection light incident on the projection optical system 23 correctly passes through the projection optical system 23 in terms of light fall-off, color separation, edge part curvature, and the like.

The shift mechanism is implemented by at least one of an optical system shift mechanism that performs optical system shifting, or an electronic shift mechanism that performs electronic shifting.

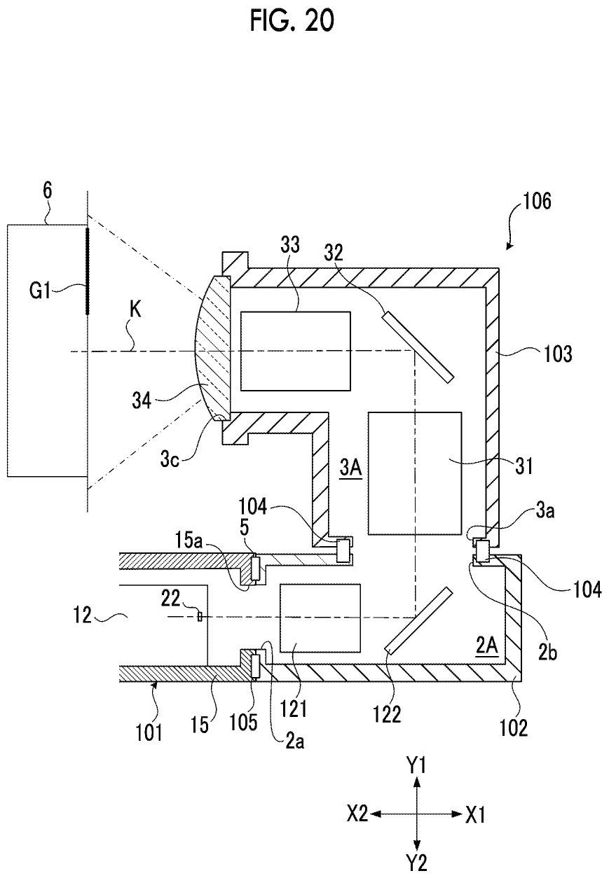

The optical system shift mechanism is, for example, a mechanism (for example, refer to FIG. 5 and FIG. 20) that moves the projection optical system 23 in a direction perpendicular to an optical axis, or a mechanism that moves the optical modulation portion 22 in the direction perpendicular to the optical axis instead of moving the projection optical system 23. In addition, the optical system shift mechanism may perform the movement of the projection optical system 23 and the movement of the optical modulation portion 22 in combination with each other.

The electronic shift mechanism is a mechanism that performs pseudo shifting of the projection range by changing a range through which the light is transmitted in the optical modulation portion 22.

In addition, the first projection apparatus 10a may comprise a projection direction changing mechanism that moves the image circle and the projection range of the projection optical system 23. The projection direction changing mechanism is a mechanism that changes a projection direction of the projection portion 1 by changing a direction of the projection portion 1 via mechanical rotation (for example, refer to FIG. 20).

### <Mechanical Configuration of Projection Apparatus 10>

FIG. 4 is a schematic diagram illustrating an exterior configuration of the projection apparatus 10. FIG. 5 is a schematic cross-sectional view of an optical unit 106 of the projection apparatus 10 illustrated in FIG. 4. FIG. 5 illustrates a cross section in a plane along an optical path of light emitted from a body part 101 illustrated in FIG. 4.

As illustrated in FIG. 4, the projection apparatus 10 comprises the body part 101 and the optical unit 106 that is provided to protrude from the body part 101. In the configuration illustrated in FIG. 4, the operation reception portion 2; the control portion 4; the light source 21, the optical modulation portion 22, and the control circuit 24 in the projection portion 1; and the communication portion 5 are provided in the body part 101. The projection optical system 23 in the projection portion 1 is provided in the optical unit 106.

The optical unit 106 comprises a first member 102 supported by the body part 101. The optical unit 106 may be configured to be attachable to and detachable from the body part 101 (in other words, configured to be interchangeable).

As illustrated in FIG. 5, the body part 101 includes a housing 15 in which an opening 15a for passing light is formed in a part connected to the optical unit 106.

As illustrated in FIG. 4, the light source 21 and an optical modulation unit 12 including the optical modulation portion 22 (refer to FIG. 3) that generates an image by spatially modulating the light emitted from the light source 21 based on input image data are provided inside the housing 15 of the body part 101. The light emitted from the light source 21 is incident on the optical modulation portion 22 of the optical modulation unit 12 and is spatially modulated and emitted by the optical modulation portion 22.

As illustrated in FIG. 5, the image formed by the light spatially modulated by the optical modulation unit 12 is incident on the optical unit 106 through the opening 15a of the housing 15 and is projected to the projection target object 6. Accordingly, an image G1 is visible from an observer.

As illustrated in FIG. 5, the optical unit 106 comprises the first member 102 having a hollow portion 2A connected to an inside of the body part 101, a first optical system 121 disposed in the hollow portion 2A, a lens 34, and a first shift mechanism 105.

The first member 102 is a member having, for example, a rectangular cross-sectional exterior, in which an opening 2a and an opening 2b are formed in surfaces parallel to each other. The first member 102 is supported by the body part 101 in a state where the opening 2a is disposed at a position facing the opening 15a of the body part 101. The light emitted from the optical modulation portion 22 of the optical modulation unit 12 of the body part 101 is incident into the hollow portion 2A of the first member 102 through the opening 15a and the opening 2a.

An incidence direction of the light incident into the hollow portion 2A from the body part 101 will be referred to as a direction X1. A direction opposite to the direction X1 will be referred to as a direction X2. The direction X1 and the direction X2 will be collectively referred to as a direction X. In addition, a direction from the front to the back of the page of FIG. 5 and its opposite direction will be referred to as a direction Z. In the direction Z, the direction from the front to the back of the page will be referred to as a direction Z1, and the direction from the back to the front of the page will be referred to as a direction Z2.

In addition, a direction perpendicular to the direction X and to the direction Z will be referred to as a direction Y. In the direction Y, an upward direction in FIG. 5 will be referred to as a direction Y1, and a downward direction in FIG. 5 will be referred to as a direction Y2. In the example in FIG. 5, the projection apparatus 10 is disposed such that the direction Y2 is a vertical direction.

The projection optical system 23 illustrated in FIG. 3 is composed of the first optical system 121 and the lens 34 in the example in FIG. 5. An optical axis K of this projection optical system 23 is illustrated in FIG. 5. The first optical system 121 and the lens 34 are disposed in this order from the optical modulation portion 22 side along the optical axis K.

The first optical system 121 includes at least one lens and guides the light that is incident on the first member 102 from the body part 101 and that travels in the direction X1 to the lens 34.

The lens 34 is disposed in an end part of the first member 102 on the direction X1 side in the form of closing the opening 2b formed in this end part. The lens 34 projects the light incident from the first optical system 121 to the projection target object 6.

The first shift mechanism 105 is a mechanism for moving the optical axis K of the projection optical system (in other words, the optical unit 106) in a direction (direction Y in FIG. 5) perpendicular to the optical axis K. Specifically, the first shift mechanism 105 is configured to be capable of changing a position of the first member 102 in the direction Y with respect to the body part 101. The first shift mechanism 105 may manually move the first member 102 or electrically move the first member 102.

FIG. 5 illustrates a state where the first member 102 is moved as far as possible to the direction Y1 side by the first shift mechanism 105. By moving the first member 102 in the direction Y2 via the first shift mechanism 105 from the state illustrated in FIG. 5, a relative position between a center of the image (in other words, a center of a display surface) formed by the optical modulation portion 22 and the optical axis K changes, and the image G1 projected to the projection target object 6 can be shifted (translated) in the direction Y2.

The first shift mechanism 105 may be a mechanism that moves the optical modulation portion 22 in the direction Y instead of moving the optical unit 106 in the direction Y. Even in this case, the image G1 projected to the projection target object 6 can be moved in the direction Y.

### <Hardware Configuration of Computer 50>

FIG. 6 is a diagram illustrating an example of a hardware configuration of the computer 50. As illustrated in FIG. 6, the computer 50 illustrated in FIG. 1 comprises a processor 51, a memory 52, a communication interface 53, and a user interface 54. The processor 51, the memory 52, the communication interface 53, and the user interface 54 are connected by, for example, a bus 59.

The processor 51 is a circuit performing signal processing and is, for example, a CPU that controls the entire computer 50. The processor 51 may be implemented by other digital circuits such as an FPGA and a digital signal processor (DSP). In addition, the processor 51 may be implemented by combining a plurality of digital circuits.

The memory 52 includes, for example, a main memory and an auxiliary memory. The main memory is, for example, a random access memory (RAM). The main memory is used as a work area of the processor 51.

The auxiliary memory is, for example, a non-volatile memory such as a magnetic disk, an optical disc, or a flash memory. The auxiliary memory stores various programs for operating the computer 50. The programs stored in the auxiliary memory are loaded into the main memory and executed by the processor 51.

In addition, the auxiliary memory may include a portable memory that can be detached from the computer 50. Examples of the portable memory include a memory card such as a universal serial bus (USB) flash drive or a secure digital (SD) memory card, and an external hard disk drive.

The communication interface 53 is a communication interface that communicates with an outside of the computer 50 (for example, the first projection apparatus 10a, the second projection apparatus 10b, and the imaging apparatus 30). The communication interface 53 is controlled by the processor 51. The communication interface 53 may be a wired communication interface that performs wired communication or a wireless communication interface that performs wireless communication, or may include both of the wired communication interface and the wireless communication interface.

The user interface 54 includes, for example, an input device that receives an operation input from a user, and an output device that outputs information to the user. The input device can be implemented by, for example, a pointing device (for example, a mouse), a key (for example, a keyboard), or a remote controller. The output device can be implemented by, for example, a display or a speaker. In addition, the input device and the output device may be implemented by a touch panel or the like. The user interface 54 is controlled by the processor 51.

### <Control by Computer 50>

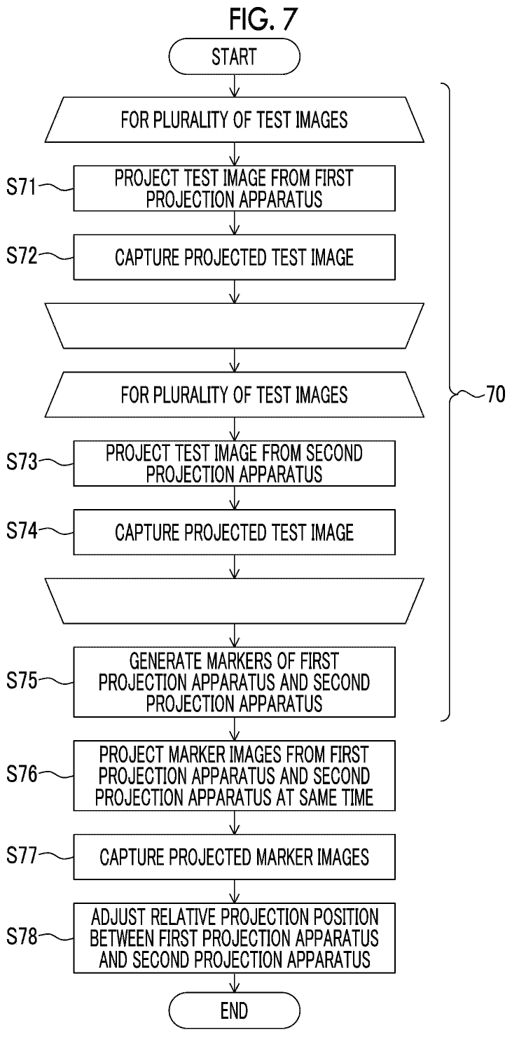

FIG. 7 is a flowchart illustrating an example of a control by the computer 50. The computer 50 executes, for example, the processing illustrated in FIG. 7. A plurality of test images to be projected by the first projection apparatus 10a and the second projection apparatus 10b are prepared in advance. The plurality of test images are test images having different combinations of a color and a pixel value (brightness). In addition, one test image may include a plurality of regions having different combinations of the color and the pixel value (brightness). The plurality of test images to be projected by the first projection apparatus 10a and the plurality of test images to be projected by the second projection apparatus 10b may be the same or different from each other.

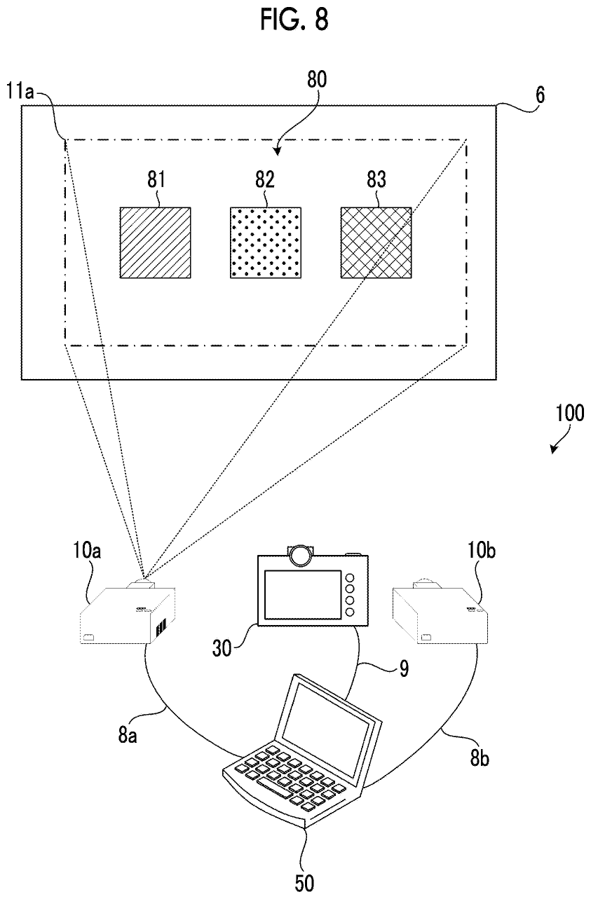

First, the computer 50 repeatedly executes steps S71 and S72 by targeting each of the plurality of test images to be projected by the first projection apparatus 10a. That is, the computer 50 performs a control of projecting the target test images from the first projection apparatus 10a by communicating with the first projection apparatus 10a (step S71). Projection of the test images by the first projection apparatus 10a will be described later (for example, refer to FIG. 8). Next, the computer 50 performs a control of capturing the test images projected in step S71 via the imaging apparatus 30 (step S72).

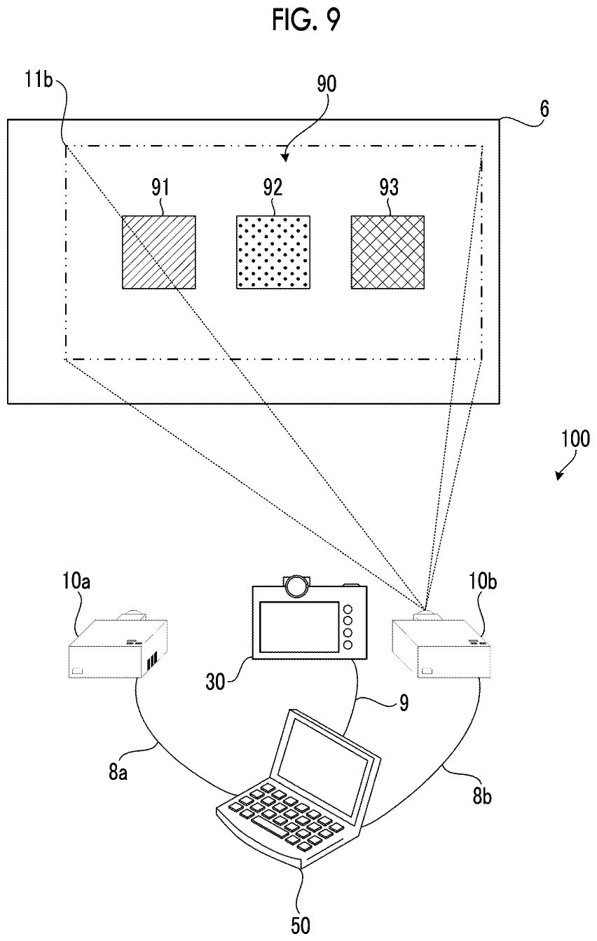

Next, the computer 50 repeatedly executes steps S73 and S74 by targeting each of the plurality of test images to be projected by the second projection apparatus 10b. That is, the computer 50 performs a control of projecting the target test images from the second projection apparatus 10b by communicating with the second projection apparatus 10b (step S73). Projection of the test images by the second projection apparatus 10b will be described later (for example, refer to FIG. 9). Next, the computer 50 performs a control of capturing the test images projected in step S73 via the imaging apparatus 30 (step S74).

The control of capturing the test images via the imaging apparatus 30 in steps S72 and S74 is, for example, a control of prompting the user of the imaging apparatus 30 to capture the test images via the imaging apparatus 30. For example, the computer 50 performs a control of outputting a message for prompting capturing of the test images via the imaging apparatus 30 by projection via the first projection apparatus 10a or the second projection apparatus 10b or by display or audio output or the like via the computer 50 or the imaging apparatus 30.

In addition, the computer 50 receives captured data of the test images obtained by imaging in steps S72 and S74 from the imaging apparatus 30. Transmission of the captured data by the imaging apparatus 30 may be automatically performed by the imaging apparatus 30 by a trigger indicating that the imaging of the imaging apparatus 30 is performed, or may be performed by a user operation after the imaging of the imaging apparatus 30. In addition, transmission of the captured data by the imaging apparatus 30 may be performed each time steps S71 and S72 or steps S73 and S74 are executed, or may be collectively performed after the repeated processing of steps S71 and S72 and the repeated processing of steps S73 and S74 are executed.

Next, the computer 50 generates markers of colors different from each other to be projected by the first projection apparatus 10a and the second projection apparatus 10b based on the captured data of each test image received from the imaging apparatus 30 (step S75). Generation of the markers based on the captured data of each test image will be described later. Processing from the start of the processing illustrated in FIG. 7 to step S75 will be referred to as marker generation processing 70.

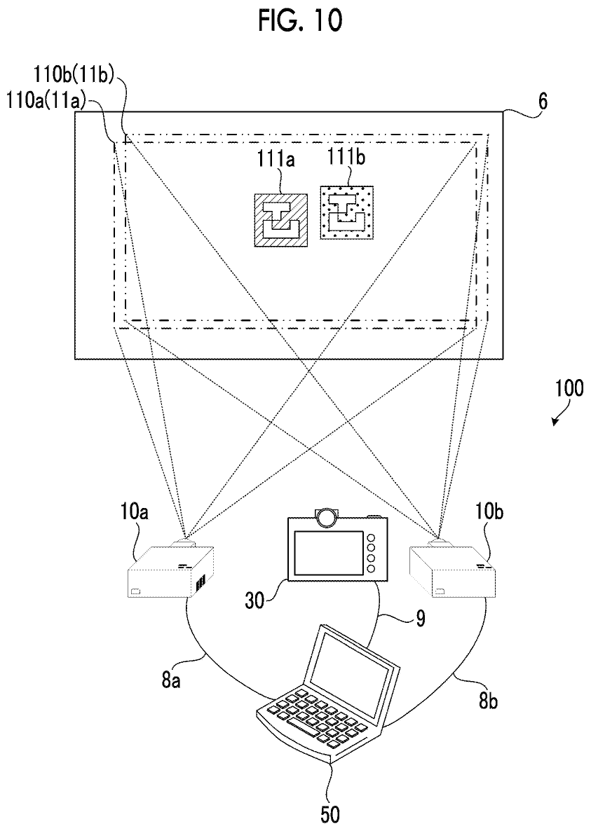

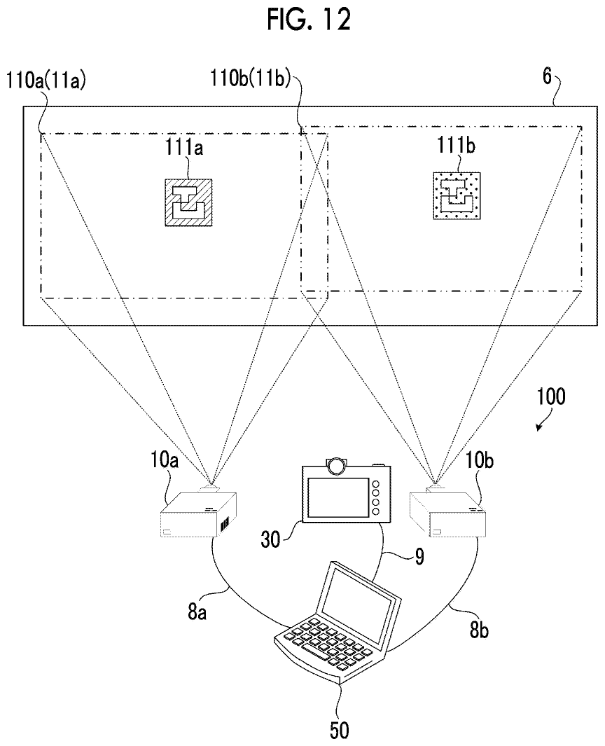

Next, the computer 50 performs a control of projecting marker images including the markers generated in step S75 to the projection target object 6 from the first projection apparatus 10a and the second projection apparatus 10b at the same time by communicating with the first projection apparatus 10a and the second projection apparatus 10b (step S76). Projection of the marker images by the first projection apparatus 10a and the second projection apparatus 10b will be described later (for example, refer to FIG. 10 and FIG. 12).

Next, the computer 50 performs a control of capturing the marker images projected in step S76 via the imaging apparatus 30 (step S77). The control of capturing the marker images via the imaging apparatus 30 in step S77 is the same as the control of capturing the test images via the imaging apparatus 30 in steps S72 and S74. In addition, the computer 50 receives captured data of the marker images obtained by imaging in step S77 from the imaging apparatus 30. Transmission of the captured data by the imaging apparatus 30 may be automatically performed by the imaging apparatus 30 by a trigger indicating that the imaging of the imaging apparatus 30 is performed, or may be performed by a user operation after the imaging of the imaging apparatus 30.

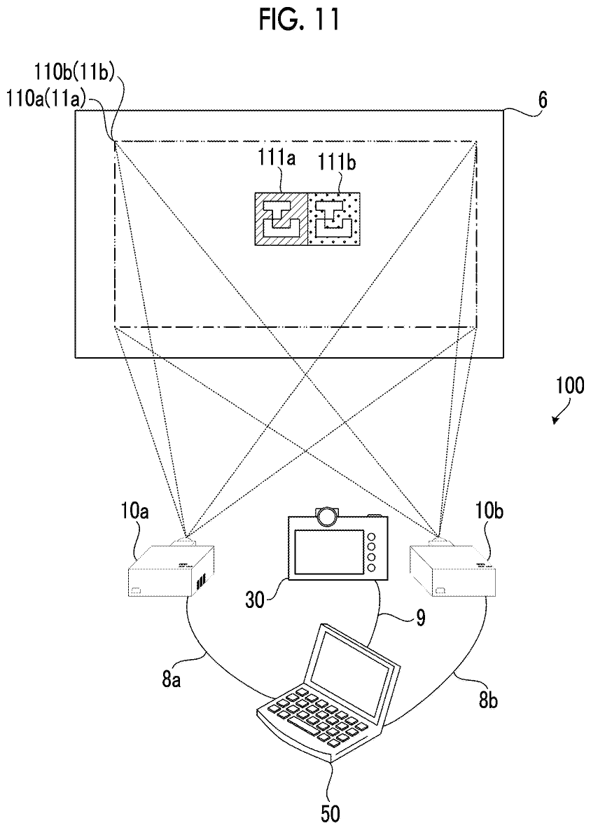

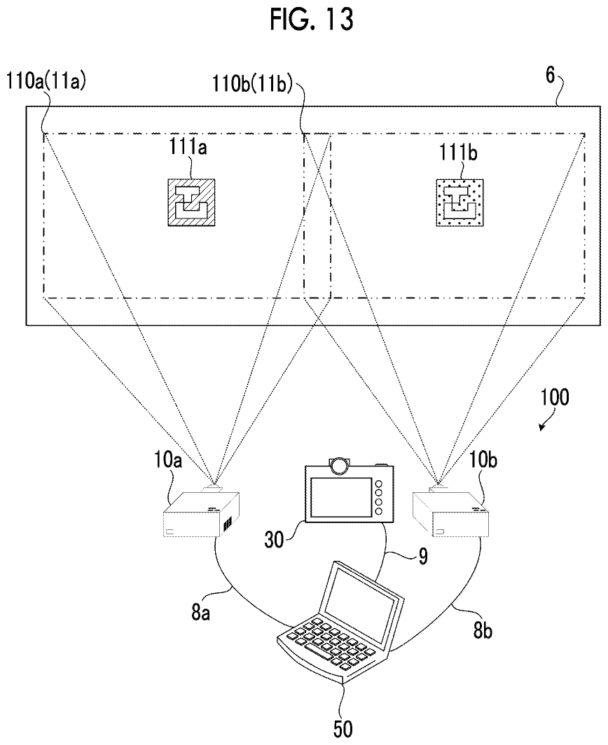

Next, the computer 50 performs a control of adjusting a relative projection position between the first projection apparatus 10a and the second projection apparatus 10b based on the captured data of the marker images received from the imaging apparatus 30 (step S78) and finishes the series of processing. Adjustment of the relative projection position between the first projection apparatus 10a and the second projection apparatus 10b will be described later (for example, refer to FIG. 11 and FIG. 13).

In the example in FIG. 7, the processing of repeating the projection of the first projection apparatus 10a and the imaging of the imaging apparatus 30 while changing the test images and then repeating the projection of the second projection apparatus 10b and the imaging of the imaging apparatus 30 while changing the test images has been described. However, the present invention is not limited to such processing. For example, the processing may be processing of repeating an operation of performing the projection of the first projection apparatus 10a and the imaging of the imaging apparatus 30 once and then performing the projection of the second projection apparatus 10b and the imaging of the imaging apparatus 30 once while changing the test images.

<Projection of Test Images by First Projection Apparatus 10a>

FIG. 8 is a diagram illustrating an example of projection of the test images by the first projection apparatus 10a. First, the computer 50 performs a control of projecting a test image 80 to the projection target object 6 from the first projection apparatus 10a.

The test image 80 includes a red region 81, a green region 82, and a blue region 83. The red region 81 is a rectangular region having a pixel value of (R, G, B)=(r1, 0, 0). The green region 82 is a rectangular region having a pixel value of (R, G, B)=(0, g1, 0). The blue region 83 is a rectangular region having a pixel value of (R, G, B)=(0, 0, b1). Each of r1, g1, and b1 is, for example, a value greater than 0 and less than or equal to 255.

The computer 50 performs a control of capturing the test image 80 projected to the projection target object 6 via the imaging apparatus 30 and receiving captured data of the test image 80 obtained by imaging from the imaging apparatus 30.

In addition, the computer 50 detects the red region 81, the green region 82, and the blue region 83 from the obtained captured data of the test image 80 via image recognition (contour extraction and the like). At this point, the first projection apparatus 10a is performing projection alone. Thus, the captured data does not include the projection image from the second projection apparatus 10b, and the red region 81, the green region 82, and the blue region 83 can be detected with high accuracy.

In addition, the computer 50 separates the captured data of the test image 80 by color into a red component (R component), a green component (G component), and a blue component (B component).

The computer 50 acquires a pixel value O^{P1}_{R|r1} of the red component of the captured data of the test image 80 in the red region 81. A pixel value of a region is, for example, an average value or a median value of pixel values of each pixel of the region. The pixel value O^{P1}_{R|r1} is the pixel value of the red component of the captured data in the red region 81 projected by the first projection apparatus 10a using the pixel value of (R, G, B)=(r1, 0, 0).

In addition, the computer 50 acquires a pixel value O^{P1}_{R|g1} of the red component of the captured data of the test image 80 in the green region 82. The pixel value O^{P1}_{R|g1} is the pixel value of the red component of the captured data in the green region 82 projected by the first projection apparatus 10a using the pixel value of (R, G, B)=(0, g1, 0).

In addition, the computer 50 acquires a pixel value O^{P1}_{R|b1} of the red component of the captured data of the test image 80 in the blue region 83. The pixel value O^{P1}_{R|b1} is the pixel value of the red component of the captured data in the blue region 83 projected by the first projection apparatus 10a using the pixel value of (R, G, B)(0, 0, b1).

In the same manner, the computer 50 acquires a pixel value O^{P1}_{G|r1} of the green component of the captured data of the test image 80 in the red region 81. In addition, the computer 50 acquires a pixel value O^{P1}_{G|g1} of the green component of the captured data of the test image 80 in the green region 82. In addition, the computer 50 acquires a pixel value O^{P1}_{G|b1} of the green component of the captured data of the test image 80 in the blue region 83.

In the same manner, the computer 50 acquires a pixel value O^{P1}_{B|r1} of the blue component of the captured data of the test image 80 in the red region 81. In addition, the computer 50 acquires a pixel value O^{P1}_{B|g1} of the blue component of the captured data of the test image 80 in the green region 82. In addition, the computer 50 acquires a pixel value O^{P1}_{B|b1} of the blue component of the captured data of the test image 80 in the blue region 83.

The computer 50 performs the above processing described in FIG. 8 with respect to a plurality of combinations of each value of r1, g1, and b1. That is, the computer 50 performs projection of the test image 80 via the first projection apparatus 10a, capturing of the projected test image 80 via the imaging apparatus 30, and acquisition of each pixel value based on the captured data obtained by imaging while changing the combination of each value of r1, g1, and b1, in other words, each pixel value of the red region 81, the green region 82, and the blue region 83.

As described above, the computer 50 projects a plurality of the test images 80 having different pixel values from the first projection apparatus 10a at different timings. Accordingly, the pixel value of each color component in the captured data obtained by capturing the marker projected by the first projection apparatus 10a can be acquired with respect to a plurality of pixel values (brightness) of the marker to be projected by the first projection apparatus 10a.

Here, while a case where the plurality of test images 80 of different pixel values including a plurality of color regions (the red region 81, the green region 82, and the blue region 83) are projected at different timings has been described, the computer 50 may project the plurality of test images 80 of different colors including regions having a plurality of pixel values at different timings. For example, the computer 50 may first project the test image 80 including a red region having a pixel value of (R, G, B)=(200, 0, 0), a red region having a pixel value of (R, G, B)=(230, 0, 0), and a red region having a pixel value of (R, G, B)=(250, 0, 0), then project the test image 80 including a green region having a pixel value of (R, G, B)=(0, 200, 0), a green region having a pixel value of (R, G, B)=(0, 230, 0), and a green region having a pixel value of (R, G B)=(0, 250, 0), and then project the test image 80 including a blue region having a pixel value of (R, G, B)=(0, 0, 200), a blue region having a pixel value of (R, G, B)=(0, 0, 230), and a blue region having a pixel value of (R, G, B)=(0, 0, 250).

That is, the computer 50 projects the plurality of the test images 80 having different combinations of the pixel value and the color from the first projection apparatus 10a at different timings. Accordingly, the pixel value of each color component in the captured data obtained by capturing the marker projected by the first projection apparatus 10a can be acquired with respect to a plurality of combinations of the pixel value and the color of the marker to be projected by the first projection apparatus 10a.

In addition, the computer 50 may project the test image 80 including regions of all combinations of the pixel value and the color from the first projection apparatus 10a.

Accordingly, by simply projecting the test image 80 once from the first projection apparatus 10a and capturing the test image 80 once via the imaging apparatus 30, the pixel value of each color component in the captured data obtained by capturing the marker projected by the first projection apparatus 10a can be acquired with respect to all combinations of the pixel value and the color of the marker to be projected by the first projection apparatus 10a.

<Projection of Test Images by Second Projection Apparatus 10b>

FIG. 9 is a diagram illustrating an example of projection of the test images by the second projection apparatus 10b. First, the computer 50 performs a control of projecting a test image 90 to the projection target object 6 from the second projection apparatus 10b.

The test image 90 includes a red region 91, a green region 92, and a blue region 93.

The red region 91 is a rectangular region having a pixel value of (R, G, B)=(r2, 0, 0). The green region 92 is a rectangular region having a pixel value of (R, G, B)=(0, g2, 0). The blue region 93 is a rectangular region having a pixel value of (R, G, B)=(0, 0, b2). Each of r2, g2, and b2 is, for example, a value greater than 0 and less than or equal to 255.

The computer 50 performs a control of capturing the test image 90 projected to the projection target object 6 via the imaging apparatus 30 and receiving captured data of the test image 90 obtained by imaging from the imaging apparatus 30.

In addition, the computer 50 detects the red region 91, the green region 92, and the blue region 93 from the obtained captured data of the test image 90 via image recognition (contour extraction and the like). At this point, the second projection apparatus 10b is performing projection alone. Thus, the captured data does not include the projection image from the first projection apparatus 10a, and the red region 91, the green region 92, and the blue region 93 can be detected with high accuracy.

In addition, the computer 50 separates the captured data of the test image 90 by color into a red component (R component), a green component (G component), and a blue component (B component).

The computer 50 acquires a pixel value O^{P2}_{R|r2} of the red component of the captured data of the test image 90 in the red region 91. The pixel value O^{P2}_{R|r2} is the pixel value of the red component of the captured data in the red region 91 projected by the second projection apparatus 10b using the pixel value of (R, G, B)=(r2, 0, 0).

In addition, the computer 50 acquires a pixel value O^{P2}_{R|g2} of the red component of the captured data of the test image 90 in the green region 92. The pixel value O^{P2}_{R|g2} is the pixel value of the red component of the captured data in the green region 92 projected by the second projection apparatus 10b using the pixel value of (R, G, B)=(0, g2, 0).

In addition, the computer 50 acquires a pixel value O^{P2}_{R|b2} of the red component of the captured data of the test image 90 in the blue region 93. The pixel value O^{P2}_{R|b2} is the pixel value of the red component of the captured data in the blue region 93 projected by the second projection apparatus 10b using the pixel value of (R, G, B)=(0, 0, b2).

In the same manner, the computer 50 acquires a pixel value O^{P2}_{G|r2} of the green component of the captured data of the test image 90 in the red region 91. In addition, the computer 50 acquires a pixel value O^{P2}_{G|g2} of the green component of the captured data of the test image 90 in the green region 92. In addition, the computer 50 acquires a pixel value O^{P2}_{G|b2} of the green component of the captured data of the test image 90 in the blue region 93.

In the same manner, the computer 50 acquires a pixel value O^{P2}_{B|r2} of the blue component of the captured data of the test image 90 in the red region 91. In addition, the computer 50 acquires a pixel value O^{P2}_{B|g2} of the blue component of the captured data of the test image 90 in the green region 92. In addition, the computer 50 acquires a pixel value O^{P2}_{B|b2} of the blue component of the captured data of the test image 90 in the blue region 93.

The computer 50 performs the above processing described in FIG. 9 with respect to a plurality of combinations of each value of r2, g2, and b2. That is, the computer 50 performs projection of the test image 90 via the second projection apparatus 10b, capturing of the projected test image 90 via the imaging apparatus 30, and acquisition of each pixel value based on the captured data obtained by imaging while changing the combination of each value of r2, g2, and b2, in other words, each pixel value of the red region 91, the green region 92, and the blue region 93.

As described above, the computer 50 projects a plurality of the test images 90 having different pixel values from the second projection apparatus 10b at different timings.

Accordingly, the pixel value of each color component in the captured data obtained by capturing the marker projected by the second projection apparatus 10b can be acquired with respect to a plurality of pixel values (brightness) of the marker to be projected by the second projection apparatus 10b.

Here, while a case where the plurality of test images 90 of different pixel values including a plurality of color regions (the red region 91, the green region 92, and the blue region 93) are projected at different timings has been described, the computer 50 may project the plurality of test images 90 of different colors including regions having a plurality of pixel values at different timings. For example, the computer 50 may first project the test image 90 including a red region having a pixel value of (R, G, B)=(200, 0, 0), a red region having a pixel value of (R, G, B)=(230, 0, 0), and a red region having a pixel value of (R, G, B)=(250, 0, 0), then project the test image 90 including a green region having a pixel value of (R, G, B)=(0, 200, 0), a green region having a pixel value of (R, G, B)=(0, 230, 0), and a green region having a pixel value of (R, G, B)=(0, 250, 0), and then project the test image 90 including a blue region having a pixel value of (R, G, B)=(0, 0, 200), a blue region having a pixel value of (R, G, B)=(0, 0, 230), and a blue region having a pixel value of (R, G, B)=(0, 0, 250).

That is, the computer 50 projects the plurality of the test images 90 having different combinations of the pixel value and the color from the second projection apparatus 10b at different timings. Accordingly, the pixel value of each color component in the captured data obtained by capturing the marker projected by the second projection apparatus 10b can be acquired with respect to a plurality of combinations of the pixel value and the color of the marker to be projected by the second projection apparatus 10b.

In addition, the computer 50 may project the test image 90 including regions of all combinations of the pixel value and the color from the second projection apparatus 10b. Accordingly, by simply projecting the test image 90 once from the second projection apparatus 10b and capturing the test image 90 once via the imaging apparatus 30, the pixel value of each color component in the captured data obtained by capturing the marker projected by the second projection apparatus 10b can be acquired with respect to all combinations of the pixel value and the color of the marker to be projected by the second projection apparatus 10b.

### <Generation of Markers Based on Captured Data of Test Images 80 and 90>

The computer 50 derives a combination that has the highest evaluation value while satisfying a predetermined condition from a plurality of combinations of the color of the marker to be projected by the first projection apparatus 10a, the pixel value of the marker to be projected by the first projection apparatus 10a, the color of the marker to be projected by the second projection apparatus 10b, and the pixel value of the marker to be projected by the second projection apparatus 10b.

For example, in a case where the pixel value of the marker to be projected by the first projection apparatus 10a is (R, G, B)=(r1, g1, b1) and the pixel value of the marker to be projected by the second projection apparatus 10b is (R, G, B)=(r2, g2, b2), the above combination can be represented by a combination of (r1, g1, b1, r2, g2, b2). However, only the value of one of r1, g1, and b1 is a value greater than 0 and less than or equal to 255, and the rest of the values are 0. In addition, only the value of one of r2, g2, and b2 is a value greater than 0 and less than or equal to 255, and the rest of the values are 0.

For example, a combination of (r1, g1, b1, r2, g2, b2)=(255, 0, 0, 0, 255, 0) indicates a combination for projecting a red marker having a pixel value of (R, G, B)=(255, 0, 0) via the first projection apparatus 10a and projecting a green marker having a pixel value of (R, G, B)=(0, 255, 0) via the second projection apparatus 10b.

First, an evaluation value E_{RG}(r1, b2) in a case where the first projection apparatus 10a projects a red marker having the pixel value of (R, G, B)=(r1, 0, 0) and the second projection apparatus 10b projects a blue marker having the pixel value of (R, G, B)=(0, 0, b2) will be described.

Expression (1) and Expression (2) below are preconditions based on projection of the red marker by the first projection apparatus 10a and projection of the blue marker by the second projection apparatus 10b.

$${O}_{R \vert r 1}^{P 1} > {O}_{R \vert b 2}^{P 2} \qquad ( 1 )$$

$${O}_{B \vert b 2}^{P 2} > {O}_{B \vert r 1}^{P 1} \qquad ( 2 )$$

Expression (3) below is a condition for causing a total of the pixel value of the red component in captured data of the red marker projected by the first projection apparatus 10a and the pixel value of the red component in captured data of the blue marker projected by the second projection apparatus 10b to be less than or equal to a maximum pixel value (255) of the imaging of the imaging apparatus 30. Expression (4) below is a condition for causing a total of the pixel value of the blue component in the captured data of the blue marker projected by the second projection apparatus 10b and the pixel value of the blue component in the captured data of the red marker projected by the first projection apparatus 10a to be less than or equal to the maximum pixel value (255) of the imaging of the imaging apparatus 30.

$${O}_{R \vert r 1}^{P 1} + {O}_{R \vert b 2}^{P 2} \leq 255 \qquad ( 3 )$$

$${O}_{B \vert b 2}^{P 2} + {O}_{B \vert r 1}^{P 1} \leq 255 \qquad ( 4 )$$

The evaluation value E_{RG}(r1, b2) in (5) below is a total of a difference (a range of the red component) between the pixel value of the red component in the captured data of the red marker projected by the first projection apparatus 10a and the pixel value of the red component in the captured data of the blue marker projected by the second projection apparatus 10b and a difference (a range of the blue component) between the pixel value of the blue component in the captured data of the blue marker projected by the second projection apparatus 10b and the pixel value of the blue component in the captured data of the red marker projected by the first projection apparatus 10a.

$${E}_{RG} ( r 1 , b 2 ) = ( {O}_{R \vert r 1}^{P 1} - {O}_{R \vert b 2}^{P 2} ) + ( {O}_{B \vert b 2}^{P 2} - {O}_{B \vert r 1}^{P 1} ) \qquad ( 5 )$$

The computer 50 derives a combination of r1 and b2 that has the highest evaluation value E_{RG}(r1, b2) shown in Expression (5) above while satisfying Expressions (1) to (4) above from a plurality of combinations of r1 and b2.

Accordingly, it is possible to derive a combination of r1 and b2 that makes it easy to separate and extract the red marker and the blue marker in an overlapping part while suppressing saturation of the pixel value in the captured data of the overlapping part in a case where the red marker projected by the first projection apparatus 10a and the blue marker projected by the second projection apparatus 10b overlap with each other.

That is, for example, in a case where the first projection apparatus 10a projects the red marker and the second projection apparatus 10b projects the blue marker, it is not always optimal to use the red marker having the pixel value of (R, G, B)=(255, 0, 0) and the blue marker having the pixel value of (R, G, B)=(0, 0, 255) for detecting each marker from the captured data. For example, even in a case where the first projection apparatus 10a projects an image having the pixel value of (R, G, B)=(255, 0, 0), the obtained captured data comes to have the green component or the blue component because of the optical system of the first projection apparatus 10a, characteristics of the projection target object 6, imaging characteristics of the imaging apparatus 30, ambient light, and the like and does not always result in captured data having the pixel value of (R, G, B)=(255, 0, 0). In the same manner, even in a case where the second projection apparatus 10b projects an image having the pixel value of (R, G, B)=(0, 0, 255), the obtained image data does not always result in captured data having the pixel value of (R, G, B)=(0, 0, 255). Regarding this point, the computer 50 derives characteristics of optimal markers to be projected by the first projection apparatus 10a and the second projection apparatus 10b based on actual measurement values of characteristics of the captured data obtained in a case where the first projection apparatus 10a and the second projection apparatus 10b projects images with combinations of each characteristic (the color and the pixel value).

While a case where the total of the range of the red component (O^{P1}_{R|r1}-O^{P2}_{R|b2}) and the range of the blue component (O^{P2}_{B|b2}-O^{P1}_{B|r1}) is used as the evaluation value ERG in Expression (5) has been described, the evaluation value ERG is not limited thereto. For example, various representative values such as an average value, a minimum value, and a product (includes a normalized product) of the range of the red component and the range of the blue component can be used as the evaluation value E_{RG}. For example, by deriving the combination of r1 and b2 having the highest evaluation value E_{RG} using the minimum value of the range of the red component and the range of the blue component as the evaluation value E_{RG}, it is possible to avoid deriving a combination of r1 and b2 that makes it easy to separate and extract one of the red marker and the blue marker and that makes it difficult to separate and extract the other.

The computer 50 may derive the combination of r1 and b2 that has the highest evaluation value E_{RG}(r1, b2) shown in Expression (5) above while satisfying Expressions (1) to (4) above from a plurality of combinations of r1 and b2 further satisfying Expression (6) below. Accordingly, a calculation amount can be reduced by narrowing down the number of combinations of r1 and b2 as an evaluation target.

$$200 \leq r 1 \leq 255 \qquad ( 6 )$$

$$200 \leq b 2 \leq 255$$

In addition, the computer 50 also derives a combination of the pixel values of each marker to be projected by the first projection apparatus 10a and the second projection apparatus 10b with respect to other combinations of the colors of each marker to be projected by the first projection apparatus 10a and the second projection apparatus 10b. The computer 50 determines a combination having the highest evaluation value among the derived combinations of the color and the pixel value of the markers as a combination of the color and the pixel value of each marker to be projected by the first projection apparatus 10a and the second projection apparatus 10b.

In other words, the computer 50 derives the combination that satisfies the predetermined condition and that has the highest evaluation value from a plurality of combinations of (r1, g1, b1, r2, g2, b2). For example, it is assumed that a combination of (r1, g1, b1, r2, g2, b2)=(250, 0, 0, 0, 245, 0) satisfies the predetermined condition and has the highest evaluation value. In this case, the computer 50 generates a red marker having the pixel value of (R, G, B)=(250, 0, 0) as the marker to be projected by the first projection apparatus 10a. In addition, the computer 50 generates a green marker having a pixel value of (R, G, B)=(0, 245, 0) as the marker to be projected by the second projection apparatus 10b.

As described above, the computer 50 sets at least one or more of the pixel value or the color of the markers to be projected by the first projection apparatus 10a and the second projection apparatus 10b to satisfy, for example, Expression (3) and Expression (4) above based on a total of the pixel values of a specific color included in the captured data of the test images 80 and 90.

In addition, the computer 50 sets at least one or more of the pixel value or the color of the markers to be projected by the first projection apparatus 10a and the second projection apparatus 10b to have the highest evaluation value in, for example, Expression (5) above based on a size of a difference between the pixel values of the specific color included in the captured data of the test images 80 and 90.

<Projection of Marker Images by First Projection Apparatus 10a and Second Projection Apparatus 10b>

FIG. 10 is a diagram illustrating an example of projection of the marker images by the first projection apparatus 10a and the second projection apparatus 10b. The computer 50 performs a control of projecting a marker image 110a from the first projection apparatus 10a and a marker image 110b from the second projection apparatus 10b to the projection target object 6 at the same time. Projecting the marker images 110a and 110b at the same time means that there is an overlapping period between a period in which the marker image 110a is projected and a period in which the marker image 110b is projected. The marker images 110a and 110b are captured in the overlapping period.

The marker image 110a is an image including a marker 111a generated as the marker to be projected by the first projection apparatus 10a. The marker 111a is a red marker in the example in FIG. 10. The marker image 110b is an image including a marker 111b generated as the marker to be projected by the second projection apparatus 10b. The marker 111b is a green marker in the example in FIG. 10.

The marker 111a and the marker 111b are images of a predetermined shape easily recognized via image recognition and the like. The marker 111a and the marker 111b are ArUco markers in the example in FIG. 10. However, the marker 111a and the marker 111b may be other markers such as Quick Response (QR) codes (registered trademark). In addition, while the marker 111a and the marker 111b are markers of the same shape in the example in FIG. 10, the marker 111a and the marker 111b may be markers of shapes different from each other.

The computer 50 performs a control of capturing the marker images 110a and 110b projected to the projection target object 6 via the imaging apparatus 30 and receiving the captured data obtained by imaging from the imaging apparatus 30. The computer 50 detects the marker 111a and the marker 111b from the obtained captured data via image recognition and the like.

For example, the computer 50 extracts a component of the color (in this example, red) of the marker 111a projected by the first projection apparatus 10a from the captured data. The computer 50 performs detection processing of detecting a part matching the original shape of the marker 111a among parts having the pixel value greater than or equal to a threshold value as the marker 111a by comparing the pixel value of each pixel of the extracted component with the threshold value. In addition, in a case where the marker 111a is not detected, the computer 50 changes the threshold value and performs the detection processing again.

In addition, the computer 50 extracts a component of the color (in this example, green) of the marker 111b projected by the second projection apparatus 10b from the captured data. The computer 50 performs detection processing of detecting the marker 111b based on the extracted component. The detection processing of detecting the marker 111b is the same as the detection processing of detecting the marker 111a.

In the example in FIG. 10, the marker 111a and the marker 111b do not overlap with each other. Thus, the detection can be performed with high accuracy. In addition, even in a case where the marker 111a and the marker 111b overlap with each other, the marker 111a and the marker 111b can be detected with high accuracy because the marker 111a and the marker 111b are generated to suppress saturation of the pixel value of the captured data in the overlapping part and to make it easy to separate and extract each marker as described above.

The computer 50 specifies a relative position between current states of the projection range 11a of the first projection apparatus 10a and the projection range 11b of the second projection apparatus 10b based on each position at which the marker 111a and the marker 111b are detected in the captured data.

### <Adjustment of Projection Position for Stack Projection>

FIG. 11 is a diagram illustrating an example of adjustment of a projection position for stack projection. In the example in FIG. 11, a case where the stack projection for improving a dynamic range and gradation representation is performed by superimposing the entire projection range 11a of the first projection apparatus 10a and the entire projection range lib of the second projection apparatus 10b on each other and projecting the same image from the first projection apparatus 10a and the second projection apparatus 10b will be described.

The computer 50 adjusts the relative projection position between the first projection apparatus 10a and the second projection apparatus 10b to superimpose the entire projection range 11a and the entire projection range lib on each other based on the specified relative position between the current states of the projection range 11a of the first projection apparatus 10a and the projection range 11b of the second projection apparatus 10b. This adjustment can be performed by, for example, controlling the shift mechanism (the optical system shift mechanism or the electronic shift mechanism) of at least any of the first projection apparatus 10a or the second projection apparatus 10b.

For example, as illustrated in FIG. 11, by controlling the shift mechanism of the second projection apparatus 10b to adjust the projection range lib based on the projection range 11a of the first projection apparatus 10a, the computer 50 enables the stack projection by superimposing the entire projection range 11a and the entire projection range 11b on each other.

For example, in the case of using the electronic shift mechanism, the computer 50 calculates a conversion parameter for correcting the projection range 11b to cause the projection range 11b to match the projection range 11a. The conversion parameter includes, for example, a projective transformation (homography) matrix. The computer 50 can cause the projection range 11b to match the projection range 11a by correcting an input image of the second projection apparatus 10b using the calculated conversion parameter and performing the projection from the second projection apparatus 10b.

A case of performing a projection adjustment control in the stack projection of projecting the same image from the first projection apparatus 10a and the second projection apparatus 10b by superimposing the entire projection range 11a of the first projection apparatus 10a and the entire projection range 11b of the second projection apparatus 10b on each other with respect to the projection of the first projection apparatus 10a and the second projection apparatus 10b has been described. However, a form of performing the projection adjustment control with respect to the projection of the first projection apparatus 10a and the second projection apparatus 10b is not limited thereto.

For example, blending projection for achieving a large projection screen by superimposing an end part of the projection range 11a of the first projection apparatus 10a and an end part of the projection range 11b of the second projection apparatus 10b on each other and projecting divided images into which a large image is divided from each of the first projection apparatus 10a and the second projection apparatus 10b may be performed.

### <State Before Adjustment of Projection Position for Blending Projection>

FIG. 12 is a diagram illustrating an example of a state before adjustment of the projection position for the blending projection. In the example in FIG. 12, in order to perform the blending projection, positions and directions of the first projection apparatus 10a and the second projection apparatus 10b are adjusted to superimpose only the end part of the projection range 11a and only the end part of the projection range 11b on each other.

Even in this case, the computer 50 performs a control of projecting the marker images 110a and 110b including the markers 111a and 111b generated through the marker generation processing 70 illustrated in FIG. 7 from the first projection apparatus 10a and the second projection apparatus 10b, capturing the projected marker images 110a and 110b via the imaging apparatus 30, and receiving the captured data obtained by imaging from the imaging apparatus 30, in the same manner as in the case of the stack projection.

Next, the computer 50 detects the marker 111a and the marker 111b from the obtained captured data via image recognition and the like. The computer 50 specifies the relative position between the current states of the projection range 11a of the first projection apparatus 10a and the projection range 11b of the second projection apparatus 10b based on each position at which the marker 111a and the marker 111b are detected in the captured data.

### <Adjustment of Projection Position for Blending Projection>

FIG. 13 is a diagram illustrating an example of adjustment of the projection position for the blending projection. The computer 50 adjusts the relative projection position between the first projection apparatus 10a and the second projection apparatus 10b to superimpose a specific region (for example, a region having a certain width at the right end) of the projection range 11a and a specific region (for example, a region having a certain width at the left end) of the projection range 11b on each other based on the specified relative position between the current states of the projection range 11a of the first projection apparatus 10a and the projection range 11b of the second projection apparatus 10b. The specific region of the projection range 11a and the specific region of the projection range 11b have the same size.

A method of adjusting the relative projection position between the first projection apparatus 10a and the second projection apparatus 10b is the same as that in the case of the stack projection.

In addition, the computer 50 performs blending processing such as halving brightness of the projection image from each of the first projection apparatus 10a and the second projection apparatus 10b with respect to the superimposed part between the projection ranges 11a and 11b. Accordingly, incongruity such that only the superimposed part between the projection ranges 11a and 11b is brightly displayed can be reduced.

While a case where the marker image 110a includes one marker 111a has been described in the examples in FIG. 10 to FIG. 13, the marker image 110a may include a plurality of the markers 111a in arrangement. In addition, while a case where the marker image 110b includes one marker 111b has been described, the marker image 110b may include a plurality of the markers 111b in arrangement.

As described above, the computer 50 projects the test images 80 and 90 (first image) from the first projection apparatus 10a and the second projection apparatus 10b (a plurality of projection apparatuses) at different timings and projects the marker images 110a and 110b (second image) including the markers 111a and 111b (markers having different colors) from the first projection apparatus 10a and the second projection apparatus 10b at the same time based on the captured data of the projected test images 80 and 90.

Specifically, the computer 50 sets the colors and the pixel values of the markers 111a and 111b of the marker images 110a and 110b (second image) based on the captured data of the test images 80 and 90 (first image). The colors of the markers 111a and 111b may be set in advance. For example, in a case where the colors of the markers 111a and 111b are set in advance as red and green, the computer 50 sets the pixel value r1 of the marker 111a having the pixel value of (R, G, B)=(r1, 0, 0) and the pixel value b1 of the marker 111b having the pixel value of (R, G, B)=(0, g1, 0) based on the captured data of the test images 80 and 90 (first image).

Accordingly, the markers 111a and 111b that are easily detected even in the case of overlapping with each other can be generated, projected at the same time, and captured. Accordingly, it is possible to accurately detect the markers 111a and 111b from the captured data obtained by capturing the markers 111a and 111b projected at the same time and, based on its result, accurately specify the relative projection position between the first projection apparatus 10a and the second projection apparatus 10b. Thus, the relative projection position between the first projection apparatus 10a and the second projection apparatus 10b can be accurately adjusted.

In addition, since the markers 111a and 111b projected at the same time can be collectively captured, the relative projection position between the first projection apparatus 10a and the second projection apparatus 10b can be accurately specified without being affected by a shake of the imaging apparatus 30, unlike that in the case of projecting the markers 111a and 111b at different timings and capturing the markers 111a and 111b. Accordingly, for example, even in a case where the imaging of the imaging apparatus 30 is handheld imaging without using a tripod or a seat, the relative projection position between the first projection apparatus 10a and the second projection apparatus 10b can be accurately specified and adjusted.

The computer 50 may set shapes and sizes of the markers 111a and 111b (images of the markers 111a and 111b) based on the captured data of the test images 80 and 90 (first image).

### <Optimization Processing of Marker Re-Search Range by Computer 50>

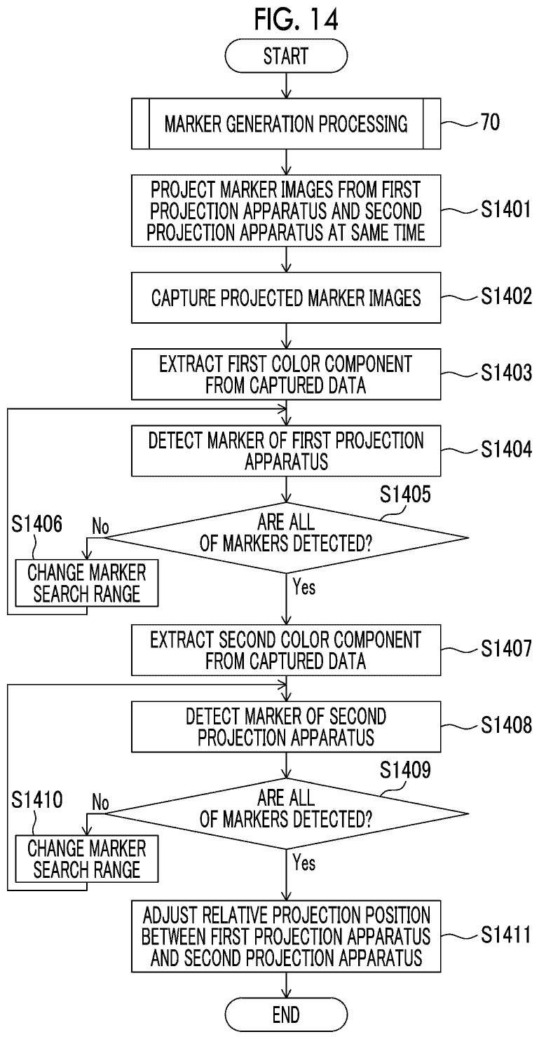

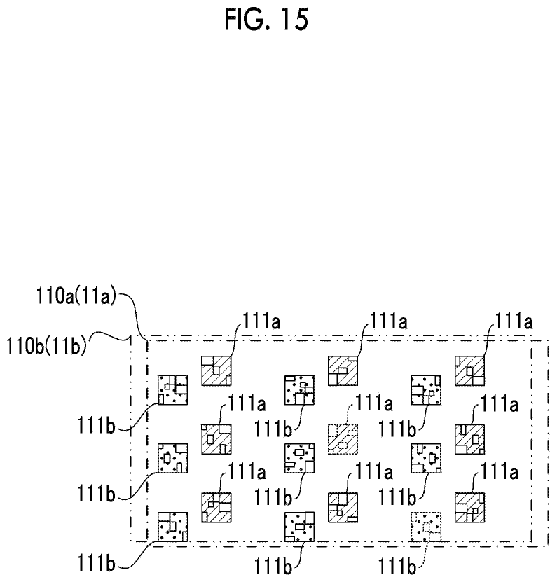

FIG. 14 is a flowchart illustrating an example of optimization processing of a marker re-search range by the computer 50. The computer 50 may execute the processing illustrated in FIG. 14. First, the computer 50 executes the marker generation processing 70 illustrated in FIG. 7. Here, it is assumed that the marker image 110a includes the plurality of markers 111a in arrangement and that the marker images 110b includes the plurality of markers 111a in arrangement (for example, refer to FIG. 15).

Next, the computer 50 performs a control of projecting the marker images 110a and 110b including the markers 111a and 111b generated by the marker generation processing 70 to the projection target object 6 from the first projection apparatus 10a and the second projection apparatus 10b at the same time (step S1401). Step S1401 is the same as step S76 in FIG. 7. Next, the computer 50 performs a control of capturing the marker images 110a and 110b projected in step S1401 via the imaging apparatus 30 (step S1402). Step S1402 is the same as step S77 in FIG. 7.

Next, the computer 50 extracts a first color component from the captured data obtained in step S1402 (step S1403). The first color component is the component of the color of the marker 111a that is generated through the marker generation processing 70 and projected by the first projection apparatus 10a. Next, the computer 50 executes processing of detecting the marker of the first projection apparatus 10a from the first color component extracted in step S1403 (step S1404).

Next, the computer 50 determines whether or not all of the markers 111a included in the marker image 110a projected by the first projection apparatus 10a in step S1401 are detected in step S1404 (step S1405).

In step S1405, in a case where all of the markers 111a are not detected (step S1405: No), the computer 50 changes a marker search range of the marker image 110a (step S1406) and returns to step S1404. Change of the marker search range of the marker image 110a will be described later (for example, refer to FIG. 15).

In step S1405, in a case where all of the markers 111a are detected (step S1405: Yes), the computer 50 extracts a second color component from the captured data obtained in step S1402 (step S1407). The second color component is the component of the color of the marker 111b that is generated through the marker generation processing 70 and projected by the second projection apparatus 10b. Next, the computer 50 executes processing of detecting the marker of the second projection apparatus 10b from the second color component extracted in step S1407 (step S1408).

Next, the computer 50 determines whether or not all of the markers 111b included in the marker image 110b projected by the second projection apparatus 10b in step S1401 are detected in step S1408 (step S1409).

In step S1409, in a case where all of the markers 111b are not detected (step S1409: No), the computer 50 changes a marker search range of the marker image 110b (step S1410) and returns to step S1408. Change of the marker search range of the marker image 110b will be described later (for example, refer to FIG. 15).

In step S1409, in a case where all of the markers 111b are detected (step S1409: Yes), the computer 50 performs a control of adjusting the relative projection position between the first projection apparatus 10a and the second projection apparatus 10b based on positions of the markers 111a and 111b detected in steps S1404 and S1408 (step S1411) and finishes the series of processing. Step S1411 is the same as step S78 in FIG. 7.

### <Optimization of Marker Re-Search Range>

FIG. 15 is a diagram for describing an example of optimization of the marker re-search range. In FIG. 15, a specific example of optimization of the marker re-search range through the processing illustrated in FIG. 14 will be described. For example, in step S1401 illustrated in FIG. 14, it is assumed that the marker image 110a including nine markers 111a arranged in a 3×3 matrix is projected from the first projection apparatus 10a and that the marker image 110b including nine markers 111b arranged in a 3×3 matrix is projected from the second projection apparatus 10b, as illustrated in FIG. 15.

In step S1404 illustrated in FIG. 14, it is assumed that only the marker 111a at the center among the nine markers 111a is not detected. In this case, the computer 50, in step S1406, changes the marker search range in the first color component extracted in step S1403.

For example, the initial marker search range in the first color component is the entire region of the first color component. Regarding this point, the computer 50 estimates the position of the non-detected marker 111a at the center based on the positions of the eight detected markers 11a.

For example, the nine markers 111a are markers having different shapes from each other. The computer 50 can identify detected markers 111a and non-detected markers 111a among the nine markers 111a based on the shapes of the detected markers 111a. In addition, the computer 50 estimates the positions of the non-detected markers 11a based on a positional relationship among the nine markers 11a and the positions of the detected markers 11a.

The computer 50 sets a range that includes the estimated position of the marker 111a at the center and that is narrower than the marker search range before change as the marker search range after change. Accordingly, the marker search range can be limited to a range in which the non-detected marker 111a at the center is estimated to be present.

Then, the computer 50 returns to step S1404 and performs processing of detecting the markers 111a from the limited marker search range in the first color component. At this point, the computer 50, for example, can detect the non-detected marker 111a at the center by repeating the processing of detecting the markers 111a while changing a threshold value for distinguishing between a marker part and other parts.

In addition, in step S1408 illustrated in FIG. 14, it is assumed that only the marker 111b at the lower right among the nine markers 111b is not detected. In this case, the computer 50, in step S1410, changes the marker search range in the second color component extracted in step S1407.

For example, the initial marker search range in the second color component is the entire region of the second color component. Regarding this point, the computer 50 estimates the position of the non-detected marker 111b at the lower right based on the positions of the eight detected markers 111b. A method of estimating the positions of non-detected markers 111b is the same as the method of estimating the positions of the non-detected markers 111 a.

The computer 50 sets a range that includes the estimated position of the marker 111b at the lower right and that is narrower than the marker search range before change as the marker search range after change. Accordingly, the marker search range can be limited to a range in which the non-detected marker 111b at the lower right is estimated to be present.

Then, the computer 50 returns to step S1408 and performs processing of detecting the markers 111b from the limited marker search range in the second color component. At this point, the computer 50, for example, can detect the non-detected marker 111b at the lower right by repeating the processing of detecting the markers 111b while changing the threshold value for distinguishing between the marker part and the other parts.

As described above, in a case where only a part of the markers 111a among the plurality of markers 111a is detected from the captured data of the marker image 110a, the computer 50 may detect the rest of the markers 111a from the captured data of the marker image 110a based on a result of estimation of the positions of the rest of the markers 111a based on the position of the part of the markers 111a.

In addition, in a case where only a part of the markers 111b among the plurality of markers 111b is detected from the captured data of the marker image 110b, the computer 50 may detect the rest of the markers 111b from the captured data of the marker image 110b based on a result of estimation of the positions of the rest of the markers 111b based on the position of the part of the markers 111b.

Accordingly, the markers 111a and 111b that are not detected through the detection processing performed once can be detected by limiting the marker search range and performing the detection processing again. Thus, the relative projection position between the first projection apparatus 10a and the second projection apparatus 10b can be accurately specified and adjusted.

### <Optimization Processing of Marker Disposition by Computer 50>

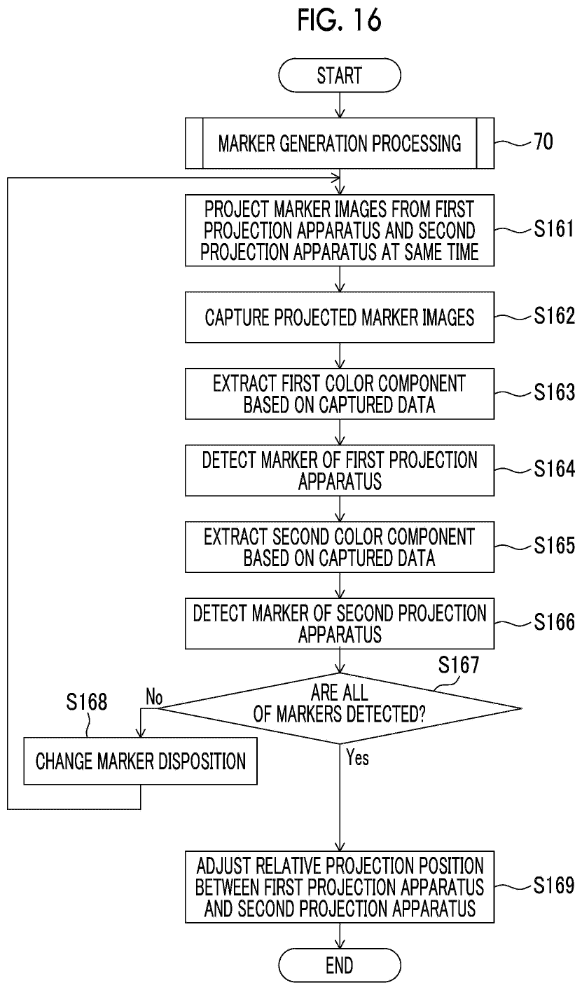

FIG. 16 is a flowchart illustrating an example of optimization processing of a marker disposition by the computer 50. The computer 50 may execute the processing illustrated in FIG. 16. First, the computer 50 executes the marker generation processing 70 illustrated in FIG. 7. Here, it is assumed that the marker image 110a includes the plurality of markers 111a in arrangement and that the marker images 110b includes the plurality of markers 111a in arrangement (for example, refer to FIG. 16).

Steps S161 to S166 illustrated in FIG. 16 are the same as steps S1401 to S1404, S1407, and S1408 illustrated in FIG. 14. After step S166, the computer 50 determines whether or not all of the markers 111a and 111b are detected in steps S164 and S166 (step S167).

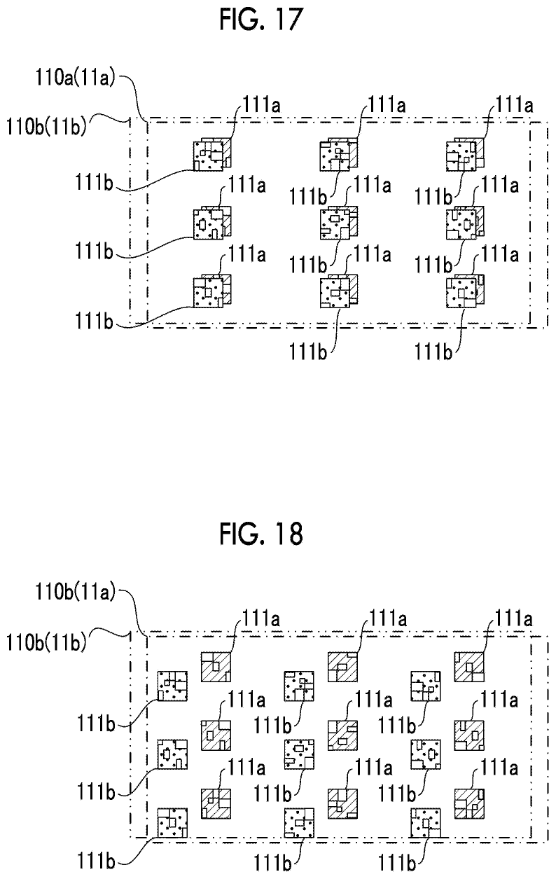

In step S167, in a case where all of the markers 111a and 111b are not detected (step S167: No), the computer 50 changes the marker disposition (step S168) and returns to step S161. Change of the marker disposition will be described later (for example, refer to FIG. 17 and FIG. 18).

In step S167, in a case where all of the markers 11a and 111b are detected (step S167: Yes), the computer 50 performs a control of adjusting the relative projection position between the first projection apparatus 10a and the second projection apparatus 10b based on the positions of the markers 111a and 111b detected in steps S164 and S166 (step S169) and finishes the series of processing. Step S169 is the same as step S78 in FIG. 7.

### <Optimization of Marker Disposition>

FIG. 17 and FIG. 18 are diagrams for describing an example of optimization of the marker disposition. In FIG. 17 and FIG. 18, a specific example of optimization of the marker disposition through the processing illustrated in FIG. 16 will be described. For example, in step S161 illustrated in FIG. 16, it is assumed that the marker image 110a including nine markers 111a is projected from the first projection apparatus 10a and that the marker image 110b including nine markers 111b is projected from the second projection apparatus 10b, as illustrated in FIG. 17.

In the example in FIG. 17, it is assumed that overlapping parts between the nine markers 111a and the nine markers 111b are increased and that at least any (for example, all) of the markers 111a or 111b are not detected in steps S164 and S166. In this case, the computer 50 changes the marker disposition by changing the marker disposition of at least any of the marker image 110a or 110b in step S168.

For example, the marker disposition of the marker image 110a is the positions of the markers 111a in the marker image 110a. In the same manner, the marker disposition of the marker image 110b is the positions of the markers 111b in the marker image 110b. For example, a plurality of the marker dispositions of the marker image 110a and a plurality of the marker dispositions of the marker image 110b are set in advance.

For example, as illustrated in FIG. 18, the computer 50 does not change the marker disposition of the marker image 110a and changes the marker disposition of the marker image 110b. Consequently, the markers 111b of the marker image 110b shift to the lower left from the state in FIG. 17. Accordingly, the overlapping parts between the markers 111a and the markers 111b disappear, and all of the markers 111a and 111b can be detected.

While the overlapping parts between the markers 111a and the markers 111b disappear in the example in FIG. 18, the overlapping parts between the markers 111a and the markers 111b may not disappear even in a case where the marker disposition is changed. However, since the markers 111a and the markers 111b are generated to suppress saturation of the pixel value of the captured data in the overlapping parts and to make it easy to separate and extract each marker, there is a high probability that all of the markers 111a and 111b can be detected in a case where the overlapping parts are decreased by changing the marker disposition.

In addition, in a case where all of the markers 111a and 111b cannot be detected even by changing the marker disposition, the computer 50 repeatedly changes the marker disposition until all of the markers 111a and 111b are detected.

The computer 50 may project the marker images 110a and 110b in which the dispositions of the markers 111a and 111b are changed based on detection results of the markers 111a and 111b from the captured data of the marker images 110a and 110b as described above, from at least any of the first projection apparatus 10a or the second projection apparatus 10b.

Accordingly, the markers 111a and 111b that are not detected through the detection processing performed once can be detected by limiting the marker disposition and performing the detection processing again. Thus, the relative projection position between the first projection apparatus 10a and the second projection apparatus 10b can be accurately specified and adjusted.

In addition, the computer 50 may perform processing of changing the images (for example, at least any of shapes, sizes, or directions) of the markers 111a and 111b in addition to changing the marker disposition or instead of changing the marker disposition.

In addition, optimization of the marker re-search range described in FIG. 14 and FIG. 15 and optimization of the marker disposition described in FIG. 16 to FIG. 18 may be used together. For example, in a case where all of the markers cannot be detected even by optimizing the marker re-search range a predetermined number of times, the computer 50 may execute optimization of the marker disposition. Specifically, in the processing illustrated in FIG. 14, the loop processing of steps S1404 to S1406 and the loop processing of steps S1408 to S1410 may be provided with an upper limit of the number of loops, and in a case where the number of loops has reached the upper limit, the computer 50 may execute step S168 in FIG. 16 and transition to step S1401.

### Modification Example 1

While a configuration in which the optical axis K is not bent has been described as a configuration of the projection apparatus 10 in FIG. 4 and FIG. 5, it may be configured to bend the optical axis K once or more by providing a reflective member in the optical unit 106.

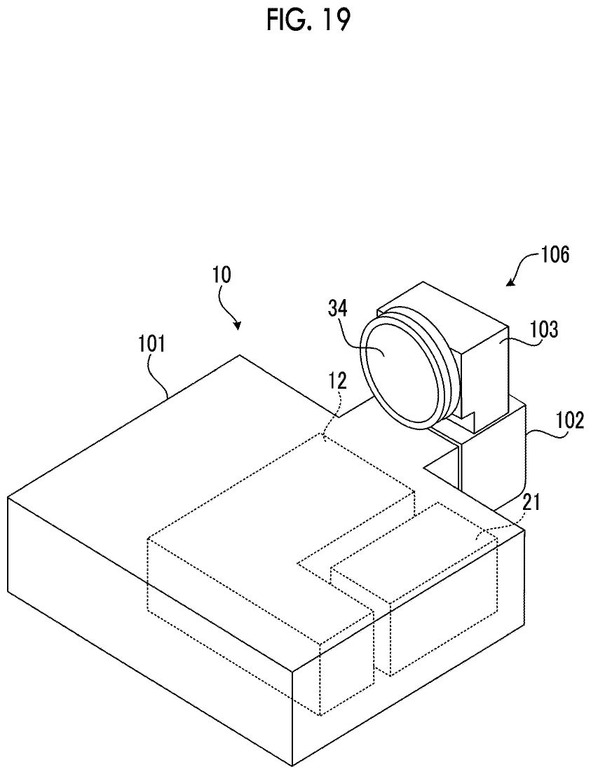

FIG. 19 is a schematic diagram illustrating another exterior configuration of the projection apparatus 10. FIG. 20 is a schematic cross-sectional view of the optical unit 106 of the projection apparatus 10 illustrated in FIG. 19. In FIG. 19 and FIG. 20, the same parts as the parts illustrated in FIG. 4 and FIG. 5 will be designated by the same reference numerals and will not be described.

As illustrated in FIG. 19, the optical unit 106 comprises a second member 103 supported by the first member 102 in addition to the first member 102 supported by the body part 101. The first member 102 and the second member 103 may be an integrated member.

As illustrated in FIG. 20, the optical unit 106 comprises, in addition to the first member 102, the second member 103 including a hollow portion 3A connected to the hollow portion 2A of the first member 102; the first optical system 121 and a reflective member 122 disposed in the hollow portion 2A; a second optical system 31, a reflective member 32, a third optical system 33, and the lens 34 disposed in the hollow portion 3A; the first shift mechanism 105; and a projection direction changing mechanism 104.

In the examples in FIG. 19 and FIG. 20, the opening 2a and the opening 2b of the first member 102 are formed in surfaces perpendicular to each other. In addition, the projection optical system 23 illustrated in FIG. 19 and FIG. 20 is composed of the reflective member 122, the second optical system 31, the reflective member 32, and the third optical system 33 in addition to the first optical system 121 and the lens 34 illustrated in FIG. 4 and FIG. 5. This projection optical system 23 has a folded form of the optical axis K that is bent twice as illustrated in FIG. 20. The first optical system 121, the reflective member 122, the second optical system 31, the reflective member 32, the third optical system 33, and the lens 34 are disposed in this order from the optical modulation portion 22 side along the optical axis K.

The first optical system 121 guides the light that is incident on the first member 102 from the body part 101 and that travels in the direction X1 to the reflective member 122. The reflective member 122 reflects the light incident from the first optical system 121 in the direction Y1. The reflective member 122 is composed of, for example, a mirror. In the first member 102, the opening 2b is formed on the optical path of the light reflected by the reflective member 122, and the reflected light travels to the hollow portion 3A of the second member 103 by passing through the opening 2b.

The second member 103 is a member having an approximately L-shaped cross-sectional exterior, in which an opening 3a is formed at a position facing the opening 2b of the first member 102. The light that has passed through the opening 2b of the first member 102 from the body part 101 is incident into the hollow portion 3A of the second member 103 through the opening 3a. The first member 102 and the second member 103 may have any cross-sectional exterior and are not limited to the above.

The second optical system 31 includes at least one lens and guides the light incident from the first member 102 to the reflective member 32. The reflective member 32 guides the light incident from the second optical system 31 to the third optical system 33 by reflecting the light in the direction X2. The reflective member 32 is composed of, for example, a mirror. The third optical system 33 includes at least one lens and guides the light reflected by the reflective member 32 to the lens 34.

The lens 34 is disposed in an end part of the second member 103 on the direction X2 side in the form of closing the opening 3c formed in this end part. The lens 34 projects the light incident from the third optical system 33 to the projection target object 6.

FIG. 20 illustrates a state where the first member 102 is moved as far as possible to the direction Y1 side by the first shift mechanism 105. By moving the first member 102 in the direction Y2 from the state illustrated in FIG. 20 via the first shift mechanism 105, a relative position between a center of the image formed by the optical modulation portion 22 and the optical axis K changes, and the image G1 projected to the projection target object 6 can be shifted in the direction Y1.

The projection direction changing mechanism 104 is a rotation mechanism that rotatably connects the second member 103 to the first member 102. By the projection direction changing mechanism 104, the second member 103 is configured to be rotatable about a rotation axis (specifically, the optical axis K) that extends in the direction Y. The projection direction changing mechanism 104 is not limited to the disposition position illustrated in FIG. 20 as long as the projection direction changing mechanism 104 can rotate the optical system. In addition, the number of rotation mechanisms is not limited to one, and a plurality of rotation mechanisms may be provided.

### Modification Example 2

While the computer 50 has been illustratively described as an example of the control device according to the embodiment of the present invention, the control device according to the embodiment of the present invention is not limited thereto. For example, the control device according to the embodiment of the present invention may be the first projection apparatus 10a or the second projection apparatus 10b. In this case, each control of the computer 50 is performed by the first projection apparatus 10a or by the second projection apparatus 10b. The first projection apparatus 10a or the second projection apparatus 10b may communicate with the imaging apparatus 30 through the computer 50 or may communicate with the imaging apparatus 30 without passing through the computer 50. In a case where the first projection apparatus 10a or the second projection apparatus 10b communicates with the imaging apparatus 30 without passing through the computer 50, it may be configured to omit the computer 50 from the projection system 100.

Alternatively, the control device according to the embodiment of the present invention may be the imaging apparatus 30. In this case, each control of the computer 50 is performed by the imaging apparatus 30. The imaging apparatus 30 may communicate with the first projection apparatus 10a and the second projection apparatus 10b through the computer 50 or may communicate with the first projection apparatus 10a and the second projection apparatus 10b without passing through the computer 50. In a case where the imaging apparatus 30 communicates with the first projection apparatus 10a and the second projection apparatus 10b without passing through the computer 50, it may be configured to omit the computer 50 from the projection system 100.

### Modification Example 3

While a case where capturing of the test image 80, capturing of the test image 90, and capturing of the marker images 110a and 110b are performed by one imaging apparatus 30 has been described, the capturing may be performed by different imaging apparatuses. However, in this case, it is desirable that each imaging apparatus has the same or similar imaging characteristic.

### Modification Example 4

While the first projection apparatus 10a and the second projection apparatus 10b have been illustratively described as an example of the plurality of projection apparatuses, the plurality of projection apparatuses may be three or more projection apparatuses (N projection apparatuses are assumed). In this case, a relative projection position among the N projection apparatuses can be adjusted by adjusting the relative projection position in the same manner as that between the first projection apparatus 10a and the second projection apparatus 10b with respect to each combination of two projection apparatuses having overlapping or adjacent projection ranges among the N projection apparatuses.

Alternatively, projection and capturing of test images may be performed in the same manner as projection and capturing of the test images 80 and 90 of the first projection apparatus 10a and the second projection apparatus 10b for each of the N projection apparatuses, and then projection of marker images at the same time and capturing of the marker images may be performed in the same manner as projection of the marker images 110a and 110b at the same time by the first projection apparatus 10a and the second projection apparatus 10b and capturing of the marker images 110a and 110b with respect to the N projection apparatuses. In this case, it is assumed that projection of the marker images at the same time by the N projection apparatuses is taken into consideration in the predetermined condition and in the evaluation value.

### Modification Example 5

A method of suppressing saturation of the pixel value of the captured data in the overlapping part between the markers 111a and 111b by deriving the combination of (r1, g1, b1, r2, g2, b2) satisfying, for example, Expression (3) and Expression (4) above in setting the combinations of the pixel values and the colors of the markers 111a and 111b to be projected by the first projection apparatus 10a and the second projection apparatus 10b has been described. However, the method of suppressing saturation of the pixel value is not limited to this method.

For example, the computer 50 may perform a control of executing capturing of the test images 80 and 90 via the imaging apparatus 30 under a plurality of exposure conditions. In this case, the computer 50 sets the brightest exposure condition among exposure conditions in which the combination of (r1, g1, b1, r2, g2, b2) not satisfying Expression (3) and Expression (4) above is not present as an exposure condition of the imaging apparatus 30.

Alternatively, the computer 50 may first project only the test images 80 and 90 in which saturation of the pixel value is likely to occur and in which the pixel value is relatively high from the first projection apparatus 10a and the second projection apparatus 10b, set the exposure condition of the imaging apparatus 30 as described above, and then project only the test images 80 and 90 for each combination of (r1, g1, b1, r2, g2, b2) from the first projection apparatus 10a and the second projection apparatus 10b.

That is, the computer 50 may set the exposure condition of the imaging apparatus 30 to satisfy, for example, Expression (3) and Expression (4) above based on the total of the pixel values of the specific color included in the captured data of the test images 80 and 90.

The computer 50 derives the combination of (r1, g1, b1, r2, g2, b2) that satisfies the predetermined condition (for example, Expression (1) and Expression (2) above) and that has the highest evaluation value (for example, Expression (5) above) based on each captured data acquired under the set exposure condition.

At least the following matters are disclosed in the present specification.

(1)

A control device comprising a processor, in which the processor is configured to perform a control of projecting a first image from a plurality of projection apparatuses at different timings, projecting a second image including markers having different colors from at least two or more projection apparatuses of the plurality of projection apparatuses based on captured data of the projected first image, and adjusting a relative projection position among the plurality of projection apparatuses based on captured data of the projected second image.

(2)

The control device according to (1), in which the processor is configured to perform a control of setting pixel values of the markers of the second image based on the captured data of the first image.

(3)

The control device according to (1) or (2), in which the processor is configured to perform a control of setting colors of the markers of the second image based on the captured data of the first image.

(4)

The control device according to (1) or (2), in which the processor is configured to perform a control of setting images of the markers of the second image based on the captured data of the first image.

(5)

The control device according to any one of (2) to (4), in which the processor is configured to perform a control of setting an exposure condition of an imaging apparatus that captures the first image and the second image, based on a total of pixel values of a specific color included in the captured data of the first image.

(6)

The control device according to (5), in which the plurality of projection apparatuses include a first projection apparatus and a second projection apparatus, and the processor is configured to perform a control of setting the exposure condition based on a pixel value of a first color included in the captured data of the first image projected by the first projection apparatus and on a pixel value of the first color included in the captured data of the first image projected by the second projection apparatus.

(7)

The control device according to (6), in which the processor is configured to perform a control of setting the exposure condition based on a pixel value of a second color included in the captured data of the first image projected by the first projection apparatus and on a pixel value of the second color included in the captured data of the first image projected by the second projection apparatus.

(8)

The control device according to any one of (2) to (4), in which the processor is configured to perform a control of setting at least one or more of the pixel values, colors, or images of the markers of the second image based on a total of pixel values of a specific color included in the captured data of the first image.

(9)

The control device according to (8), in which the plurality of projection apparatuses include a first projection apparatus and a second projection apparatus, and the processor is configured to perform a control of setting at least any of the pixel values, the colors, or the images of the markers of the second image based on a pixel value of a first color included in the captured data of the first image projected by the first projection apparatus and on a pixel value of the first color included in the captured data of the first image projected by the second projection apparatus.

(10)

The control device according to (9), in which the processor is configured to perform a control of setting at least any of the pixel values, the colors, or the images of the markers of the second image based on a pixel value of a second color included in the captured data of the first image projected by the first projection apparatus and on a pixel value of the second color included in the captured data of the first image projected by the second projection apparatus.

(11)

The control device according to any one of (2) to (10), in which the processor is configured to perform a control of setting at least one or more of the pixel values, colors, or images of the markers of the second image based on a size of a difference among pixel values of a specific color included in the captured data of the first image projected from the plurality of projection apparatuses.

(12)

The control device according to (11), in which the plurality of projection apparatuses include a first projection apparatus and a second projection apparatus, and the processor is configured to perform a control of setting at least one or more of the pixel values, the colors, or the images of the markers of the second image based on a size of a difference between a pixel value of a first color included in the captured data of the first image projected by the first projection apparatus and a pixel value of the first color included in the captured data of the first image projected by the second projection apparatus.

(13)

The control device according to (12), in which the processor is configured to perform a control of setting at least one or more of the pixel values, the colors, or the images of the markers of the second image based on a size of a difference between a pixel value of a second color included in the captured data of the first image projected by the first projection apparatus and a pixel value of the second color included in the captured data of the first image projected by the second projection apparatus.

(14)

The control device according to any one of (1) to (13), in which the processor is configured to perform a control of projecting a plurality of the first images of which at least one or more of pixel values, colors, or images are different, from the plurality of projection apparatuses at different timings.

(15)

The control device according to any one of (1) to (14), in which the processor is configured to perform a control of projecting the first image including a plurality of regions of which at least one or more of pixel values, colors, or images are different, from the plurality of projection apparatuses.

(16)

The control device according to any one of (1) to (15), in which the processor is configured to perform a control of adjusting the relative projection position among the plurality of projection apparatuses based on a result of detection of the markers from the captured data of the second image.

(17)

The control device according to (16), in which the second image includes a plurality of markers, and the processor is configured to, in a case where a part of the markers among the plurality of markers is detected from the captured data of the second image, perform a control of detecting the rest of the markers from the captured data of the second image based on a result of estimation of positions of the rest of the markers based on a position of the part of the markers.

(18)

The control device according to (16) or (17), in which the processor is configured to, based on a detection result of the markers from the captured data of the second image, perform a control of projecting the second image of which dispositions or images of the markers are changed from at least any of the plurality of projection apparatuses.

(19)

A control method of performing, via a processor included in a control device, a control of projecting a first image from a plurality of projection apparatuses at different timings, projecting a second image including markers having different colors from at least two or more projection apparatuses of the plurality of projection apparatuses based on captured data of the projected first image, and adjusting a relative projection position among the plurality of projection apparatuses based on captured data of the projected second image.

(20)

A non-transitory computer readable medium storing a control program causing a processor included in a control device to execute a control of projecting a first image from a plurality of projection apparatuses at different timings, projecting a second image including markers having different colors from at least two or more projection apparatuses of the plurality of projection apparatuses based on captured data of the projected first image, and adjusting a relative projection position among the plurality of projection apparatuses based on captured data of the projected second image.

(21)

A projection system comprising a plurality of projection apparatuses, and a control device including a processor, in which the processor is configured to perform a control of projecting a first image from a plurality of projection apparatuses at different timings, projecting a second image including markers having different colors from at least two or more projection apparatuses of the plurality of projection apparatuses based on captured data of the projected first image, and adjusting a relative projection position among the plurality of projection apparatuses based on captured data of the projected second image.

While various embodiments have been described above with reference to the drawings, the present invention is, of course, not limited to such examples. It is apparent that those skilled in the art may perceive various modification examples or correction examples within the scope disclosed in the claims, and those examples are also understood as falling within the technical scope of the present invention. In addition, each constituent in the embodiment may be used in any combination without departing from the gist of the invention.

The present application is based on Japanese Patent Application (JP2021-157091) filed on Sep. 27, 2021, the content of which is incorporated in the present application by reference.

### EXPLANATION OF REFERENCES

1: projection portion
2: operation reception portion
2A, 3A: hollow portion
2a, 2b, 3a, 3c, 15a: opening
4: control portion
4a: storage medium
5: communication portion
6: projection target object
8a, 8b, 9: communication cable
10: projection apparatus
10a: first projection apparatus
10b: second projection apparatus
11a, 11b: projection range
12: optical modulation unit
15: housing
21: light source
22: optical modulation portion
23: projection optical system
24: control circuit
30: imaging apparatus
31: second optical system
32, 122: reflective member
33: third optical system
34: lens
50: computer
51: processor
52: memory
53: communication interface
54: user interface
59: bus
70: marker generation processing
80, 90: test image
81, 91: red region
82, 92: green region
83, 93: blue region
100: projection system
101: body part
102: first member
103: second member
104: projection direction changing mechanism
105: first shift mechanism
106: optical unit
111a, 111b: marker
110a, 110b: marker image
121: first optical system
G1: image

What is claimed is:

1. A control device comprising:
a processor,
wherein the processor is configured to perform a control of:
projecting a first image from a plurality of projection apparatuses at different timings;
projecting a second image including markers having different colors from at least two or more projection apparatuses of the plurality of projection apparatuses based on captured data of the projected first image; and
adjusting a relative projection position among the plurality of projection apparatuses based on captured data of the projected second image.

2. The control device according to claim 1,
wherein the processor is configured to perform a control of setting pixel values of the markers of the second image based on the captured data of the first image.

3. The control device according to claim 1,
wherein the processor is configured to perform a control of setting colors of the markers of the second image based on the captured data of the first image.

4. The control device according to claim 1,
wherein the processor is configured to perform a control of setting images of the markers of the second image based on the captured data of the first image.

5. The control device according to claim 2,
wherein the processor is configured to perform a control of setting an exposure condition of an imaging apparatus that captures the first image and the second image, based on a total of pixel values of a specific color included in the captured data of the first image.

6. The control device according to claim 5,
wherein the plurality of projection apparatuses include a first projection apparatus and a second projection apparatus, and
the processor is configured to perform a control of setting the exposure condition based on a pixel value of a first color included in the captured data of the first image projected by the first projection apparatus and on a pixel value of the first color included in the captured data of the first image projected by the second projection apparatus.

7. The control device according to claim 6,
wherein the processor is configured to perform a control of setting the exposure condition based on a pixel value of a second color included in the captured data of the first image projected by the first projection apparatus and on a pixel value of the second color included in the captured data of the first image projected by the second projection apparatus.

8. The control device according to claim 2,
wherein the processor is configured to perform a control of setting at least one or more of the pixel values, colors, or images of the markers of the second image based on a total of pixel values of a specific color included in the captured data of the first image.

9. The control device according to claim 8,
wherein the plurality of projection apparatuses include a first projection apparatus and a second projection apparatus, and
the processor is configured to perform a control of setting at least one of the pixel values, the colors, or the images of the markers of the second image based on a pixel value of a first color included in the captured data of the first image projected by the first projection apparatus and on a pixel value of the first color included in the captured data of the first image projected by the second projection apparatus.

10. The control device according to claim 9,
wherein the processor is configured to perform a control of setting at least one of the pixel values, the colors, or the images of the markers of the second image based on a pixel value of a second color included in the captured data of the first image projected by the first projection apparatus and on a pixel value of the second color included in the captured data of the first image projected by the second projection apparatus.

11. The control device according to claim 2,
wherein the processor is configured to perform a control of setting at least one or more of the pixel values, colors, or images of the markers of the second image based on a size of a difference among pixel values of a specific color included in the captured data of the first image projected from the plurality of projection apparatuses.

12. The control device according to claim 11,
wherein the plurality of projection apparatuses include a first projection apparatus and a second projection apparatus, and
the processor is configured to perform a control of setting at least one or more of the pixel values, the colors, or the images of the markers of the second image based on a size of a difference between a pixel value of a first color included in the captured data of the first image projected by the first projection apparatus and a pixel value of the first color included in the captured data of the first image projected by the second projection apparatus.

13. The control device according to claim 12,
wherein the processor is configured to perform a control of setting at least one or more of the pixel values, the colors, or the images of the markers of the second image based on a size of a difference between a pixel value of a second color included in the captured data of the first image projected by the first projection apparatus and a pixel value of the second color included in the captured data of the first image projected by the second projection apparatus.

14. The control device according to claim 1,
wherein the processor is configured to perform a control of projecting a plurality of the first images of which at least one or more of pixel values, colors, or images are different, from the plurality of projection apparatuses at different timings.

15. The control device according to claim 1,
wherein the processor is configured to perform a control of projecting the first image including a plurality of regions of which at least one or more of pixel values, colors, or images are different, from the plurality of projection apparatuses.

16. The control device according to claim 1,
wherein the processor is configured to perform a control of adjusting the relative projection position among the plurality of projection apparatuses based on a result of detection of the markers from the captured data of the second image.

17. The control device according to claim 16,
wherein the second image includes a plurality of markers, and
the processor is configured to, in a case where a part of the plurality of markers is detected from the captured data of the second image, perform a control of detecting a rest of the plurality of markers from the captured data of the second image based on a result of estimation of positions of the rest of the plurality of markers based on a position of the part of the plurality of markers.

18. The control device according to claim 16,
wherein the processor is configured to, based on a detection result of the markers from the captured data of the second image, perform a control of projecting, from at least one of the plurality of projection apparatuses, the second image of which dispositions or images of the markers are changed.

19. A control method of performing, via a processor included in a control device, a control of:
projecting a first image from a plurality of projection apparatuses at different timings;
projecting a second image including markers having different colors from at least two or more projection apparatuses of the plurality of projection apparatuses based on captured data of the projected first image; and
adjusting a relative projection position among the plurality of projection apparatuses based on captured data of the projected second image.

20. A non-transitory computer readable medium storing a control program causing a processor included in a control device to execute a control of:
projecting a first image from a plurality of projection apparatuses at different timings;
projecting a second image including markers having different colors from at least two or more projection apparatuses of the plurality of projection apparatuses based on captured data of the projected first image; and
adjusting a relative projection position among the plurality of projection apparatuses based on captured data of the projected second image.

21. A projection system comprising:
a plurality of projection apparatuses; and
a control device including a processor,
wherein the processor is configured to perform a control of:
projecting a first image from a plurality of projection apparatuses at different timings;
projecting a second image including markers having different colors from at least two or more projection apparatuses of the plurality of projection apparatuses based on captured data of the projected first image; and
adjusting a relative projection position among the plurality of projection apparatuses based on captured data of the projected second image.
